(19) United States
(12) Patent Application Publication
(10) Pub. No.: US 2007/0073596 A1
(43) Pub. Date: Mar. 29, 2007

(54) Systems and methods for marketing and selling media

(76) Inventors: Jonathon P. Alexander, San Clemente, CA (US); Christopher P. Cox, Powell, OH (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/525,330

(22) Filed: Sep. 22, 2006

Related U.S. Application Data
(60) Provisional application No. 60/596,459, filed on Sep. 23, 2005.

(51) Int. Cl. G06Q 30/00

(52) U.S. Cl. 705/26; 705/35

(57) ABSTRACT

An apparatus to generate a playlist of media created by emerging artists for use by a media distribution center in response to purchasing decisions stored on a website comprises a storage unit configured to receive and store a plurality of media titles from a plurality of emerging artists, an interface for communicating data associated with at least a portion of the stored media titles, and a processor in communication with said storage unit and said interface. The processor is configured to permit a plurality of users to purchase a media title from the emerging artists, record sales data associated with the media titles, generate a playlist of selected media titles in response to parameters associated with the media titles and selected by a media distribution center, wherein at least one of the parameters is related to a the sales data, and transmit data associated with the selected media titles to the interface.

### CROSS-REFERENCE TO RELATED APPLICATIONS

This application claims priority under 35 U.S.C. §119(e) to U.S. Provisional Application Ser. No. 60/596,459, filed Sep. 23, 2005, entitled “A System and Method for Digital Discovery and Distribution of Media,” which is incorporated herein by reference in its entirety.

### BACKGROUND

1. Field

The embodiments disclosed herein relate generally to a computer system, and more specifically to systems and methods for marketing and selling media.

2. Description of the Related Art

Commonly, record labels, art galleries and other media distribution intermediaries facilitate the distribution of an artist's work. Typically, these intermediaries utilize distribution channels known to them in order to distribute an artist's work. Taking command of the selling and marketing process, the intermediaries retain a large portion of the sales revenue as profits and costs, remitting to the artists, by way of royalty payments, only a small fraction of the revenue.

Distribution and marketing channels such as these are problematic. In particular, the artist, the individual creating the work, often receives less money than the media distribution intermediary. Additionally, because access to the distribution channels are subject to the discretion of the media distribution intermediaries, new and emerging artists often have substantial difficulty getting a foothold in the marketplace. Furthermore, when the media distribution intermediaries act as the gatekeeper for new and emerging music, the preferences of prospective purchasers do not directly influence the quality and/or variety of media available for sale.

Because of the foregoing challenges and limitations, there is a need to provide more accessible channels for media to be marketed and sold.

### SUMMARY

The embodiments disclosed herein relate generally to a computer system, and more specifically to systems and methods for marketing and selling media.

In one embodiment, an apparatus to generate a playlist of media created by emerging artists for use by a media distribution center in response to purchasing decisions stored on a website, comprises a storage unit configured to receive and store a plurality of media titles from a plurality of emerging artists; an interface for communicating data associated with at least a portion of the stored media titles; and a processor in communication with said storage unit and said interface. The processor is configured to permit a plurality of users to purchase a media title from the emerging artists; record sales data associated with the media titles; generate a playlist of selected media titles in response to parameters associated with the media titles and selected by a media distribution center, wherein at least one of the parameters is related to a the sales data; and transmit data associated with the selected media titles to the interface.

In another embodiment, a method for generating a playlist of media created by emerging artists for use by a media distribution center in response to purchasing decisions stored on a website comprises storing a plurality of media titles from a plurality of emerging artists; communicating data associated with at least a portion of the stored media titles; permitting a plurality of users to purchase a media title from the emerging artists; recording sales data associated with the media titles; generating a playlist of selected media titles in response to parameters associated with the media titles and selected by a media distribution center, wherein at least one of the parameters is related to a the sales data; and transmitting data associated with the selected media titles.

In another embodiment, an apparatus to receive electronic media data from creators of entertainment media to be promoted and sold to the general public comprises a user input device for receiving demographic data from an emerging artist; a storage unit configured to receive and store media from the emerging artist; and a processor coupled to said storage unit. The processor is configured to create a multi-page website display unique to the emerging artist incorporating the emerging artist's media and other information about the emerging artist including the demographic data; permit a consumer user to purchase the media for a purchase price using the website; remit a portion of the purchase price of the media to the emerging artist; and transmit a digital version of the media to the consumer user.

In another embodiment, a method for receiving electronic media data from creators of entertainment media to be promoted and sold to the general public comprises receiving demographic data from an emerging artist; receiving and store media from the emerging artist; creating a multi-page website display unique to the emerging artist incorporating the emerging artist's media and other information about the emerging artist including the demographic data; permitting a consumer user to purchase the media for a purchase price using the website; remitting a portion of the purchase price of the media to the emerging artist; and transmitting a digital version of the media to the consumer user.

In another embodiment, a method for rapidly creating a functional on-line storefront for emerging artists to market and sell their media comprises receiving registration information relating to a producer user; receiving media and parameters corresponding to the media; storing the media on a first storage device and providing substantially immediate access to the media via the first storage device; copying the media from the first storage device to a second storage device and providing access to the media via the first storage device while the media is being copied; providing access to the media via the second storage device after the media has been copied to the second storage device; and permitting users to purchase or preview the media when the media is stored on either the first storage device or the second storage device.

In another embodiment, a system for rapidly creating a functional on-line storefront for emerging artists to market and sell their media comprises a computer; and software accessible to and executable by the computer. The computer is operable to receive registration information relating to a producer user; receive media and parameters corresponding to the media; store the media on a first storage device coupled locally to the computer; provide access to the media via the first storage device; transmit a copy of the media from the first storage device to a second storage device; provide access to the media via the second storage device after the media has been copied to the second storage device; and permit users to purchase or preview the media when the media is stored on either the first storage device or the second storage device.

In another embodiment, a user interface for displaying media and purchasing media from emerging artists via a media distribution center comprises a first selection area embedded in a display associated with a media distribution center that permits a user to select a media file; a second selection area embedded in the display associated with the media distribution center that permits a user to preview the selected media file; and a third selection area embedded in the display associated with the media distribution center. The third selection area is configured to entirely initiate and complete payment for the selected media file from a website owned by the media distribution center; and entirely initiate and complete distribution of the selected media file from the website owned by the media distribution center.

In another embodiment, a fee based method for directly distributing, marketing and selling media produced by an emerging artist using a digital interface comprises receiving a periodic fixed payment from a producer user; permitting the producer user to display media available for purchase; displaying a purchase price associated with the media; receiving a payment from a consumer user in the amount of the purchase price; distributing the media to the consumer user; and distributing net sales proceeds to the producer user.

In another embodiment, a commission based method for directly distributing, marketing and selling media produced by an emerging artist using a digital interface comprises permitting a producer user to display media available for purchase; displaying a purchase price associated with the media; receiving a payment from a consumer user in the amount of the purchase price; distributing the media to the consumer user; and distributing net sales proceeds less a commission to the producer user.

In another embodiment, a fee based method for using a media distribution center's website to directly distribute, market and sell media produced by an emerging artist comprises receiving a periodic fixed payment from a producer user; receiving a license fee from a media distribution center; permitting the producer user to display media available for purchase on a display screen associated with the media distribution center; displaying a purchase price associated with the media on the display screen; receiving a payment from a consumer user in the amount of the purchase price; distributing the media to the consumer user; distributing at least some of the periodic fixed payment to the media distribution center; and distributing net sales proceeds to the producer user.

In another embodiment, a commission based method for using a media distribution center's website to directly distribute, market and sell media produced by an emerging artist comprises receiving a license fee from a media distribution center; permitting the producer user to display media available for purchase on a display screen associated with the media distribution center; displaying a purchase price associated with the media on the display screen; receiving a payment from a consumer user in the amount of the purchase price; distributing the media to the consumer user; distributing net sales proceeds less a commission to the producer user; and distributing at least some of the commission to the media distribution center.

In another embodiment, an artwork sales method for the promotion of emerging artists comprises displaying an artwork available for sale from a producer user; displaying a purchase price associated with the artwork; displaying the number of copies of the artwork that are available for sale; receiving payment from a consumer user in the amount of the purchase price of the artwork; transmitting a notification to the producer user indicating that a purchase has been made; distributing to the producer user (a) net sales proceeds if the producer user pays a periodic fixed fee, or (b) net sales proceeds less a commission if the producer user does not pay a periodic fixed fee; and decrementing the number of copies available for sale in response to the consumer user's purchase.

In another embodiment, a method for keeping a talent industry executive abreast of notable events and recent developments in market trends comprises receiving one or more criteria from an industry user; monitoring parameters associated with media files to determine when the one or more criteria have been satisfied; generating a customized report summarizing the market activity of media files based on the one or more criteria; and transmitting a notification to the industry user indicating that the customized report is available to view.

In another embodiment, a system for keeping a talent industry executive abreast of notable events and recent developments in market trends comprises a computer; and software accessible to and executable by the computer. The computer is operable to receive one or more criteria from an industry user; monitor parameters associated with media files to determine when the one or more criteria have been satisfied; generate a customized report summarizing the market activity of media files based on the one or more criteria; and transmit a notification to the industry user indicating that the customized report is available to view.

In another embodiment, a system for querying a database that stores information related to media files in order to identify one or more desired media files comprises a computer; and software accessible to and executable by the computer. The computer is operable to receive one or more criteria, including a geographic source of media file; identify matching media files that satisfy the one or more criteria; and provide an indication that a media file is a matching media file.

In another embodiment, a method for querying a database that stores information related to media files in order to identify one or more desired media files comprises receiving one or more criteria, including a geographic source of a media file; identifying matching media files that satisfy the one or more criteria; and providing an indication that a media file is a matching media file.

In another embodiment, a system for automatically suggesting media to a user based on the prior media preferences of the user comprises a computer; and software accessible to and executable by the computer. The computer is operable to receive a target user history that is an indication of the media files a target user has accessed in the past; identify one or more matching users that have a similar user history to the target user; and provide a suggested media file to the target user based on (a) a comparison of the target user histories and media files, and (b) whether the target user history includes the suggested media file.

In another embodiment, a method for automatically suggesting media to a user based on the user's prior media preferences comprises receiving a target user history that is an indication of the media files a target user has accessed in the past; identifying one or more matching users that have a similar user history to the target user; and providing a suggested media file to the target user based on (a) a comparison of the target user history and media files common to the user histories of the matching users, and (b) whether the target user history includes the suggested media file.

In another embodiment, a method for automatically delivering to a talent scout media files that match the scouting interests of the talent scout comprises receiving one or more criteria from an industry user; identifying a list of one or more matching media files that satisfy the one or more criteria; delivering to the industry user the one or more matching media files; and updating the list of one or more media files by (a) removing from the list media files that have already been accessed by the industry user and (b) adding to the list media files that (i) satisfy the one or more criteria and (ii) have never been an entry in the list.

In another embodiment, a system for automatically delivering to a talent scout media files that match the scouting interests of the talent scout comprises a computer; and software accessible to and executable by the computer. The computer is operable to receive one or more criteria from an industry user; create a list of one or more matching media files that satisfy the one or more criteria; deliver to the industry user the one or more matching media files; and update the list of one or more media files by (a) removing from the list media files that have already been accessed by the industry user and (b) adding to the list media files that (i) satisfy the one or more criteria and (ii) have never been an entry in the list;

In another embodiment, a method for automatically generating a media file playlist comprises receiving one or more criteria from a user; identifying one or more matching media files that satisfy the one or more criteria; creating a list comprising the one or more media files; and playing the media files according to the list.

In another embodiment, a system for automatically generating a media file playlist comprises a computer; and software accessible to and executable by the computer. The computer is operable to receive one or more criteria from a user; identify one or more matching media files that satisfy the one or more criteria; create a list comprising the one or more media files; and play the media files according to the list.

In another embodiment, an apparatus for receiving media data to be promoted and sold to the general public comprises an input device for receiving demographic data from a producer user; a media receiving unit configured to receive media from the producer user; and a processor coupled to the media receiving unit. The processor is configured to create a playlist of media titles for playback by a reviewer; and transmit the playlist of media titles and demographic data to the reviewer's removable storage device whereby the reviewer can quickly collect all the media data deposited by the producer user and review it at his/her leisure.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1 illustrates one embodiment of a kiosk capable of housing a terminal receiving demographic data and media.

FIG. 2 is a high-level system diagram illustrating one embodiment of a system for marketing and selling media.

FIG. 3A illustrates one embodiment of a host device.

FIG. 3B illustrates one embodiment of a device used by a consumer user.

FIG. 3C illustrates one embodiment of a device used by a radio station user.

FIG. 3D illustrates one embodiment of a device used by a producer user.

FIG. 3E illustrates one embodiment of a device used by an industry user.

FIG. 4 illustrates one embodiment of a flowchart of operations for creating an account.

FIGS. 5, 5A, and 5B illustrate one embodiment of a flowchart of operations for uploading media.

FIG. 6 illustrates one embodiment of a flowchart of operations for specifying the geographic source of media.

FIG. 7 illustrates one embodiment of a flowchart of operations for providing a notification to a user and/or generating a report for a user.

FIG. 8 illustrates one embodiment of a flowchart of operations for creating an automated playlist.

FIG. 9 illustrates one embodiment of a flowchart of operations for creating a queued playlist.

FIG. 10 illustrates one embodiment of a flowchart of operations for selling digital media.

FIG. 11 illustrates one embodiment of a flowchart of operations for selling physical media.

FIGS. 12, 12A and 12B illustrate one embodiment of a flowchart of operations for distributing proceeds from the sale of media.

FIG. 13 illustrates one embodiment of a flowchart of operations for suggesting media to a user.

FIG. 14A illustrates an example of a webpage displaying an on-line media storefront where a host device provides direct service.

FIG. 14B illustrates a block diagram and pie chart related to an example of a distribution of sales proceeds for an embodiment where a host device provides direct service and a user is charged a commission for selling media.

FIG. 14C illustrates a block diagram and pie chart related to an example of a distribution of sales proceeds for an embodiment where a host device provides direct service and a user is charged a flat-fee for selling media.

FIG. 15A illustrates an example of a webpage displaying a login screen where a radio station facilitates sales of media.

FIG. 15B illustrates an example of a webpage displaying an on-line media storefront where a radio station facilitates sales of media.

FIG. 15C illustrates a block diagram and pie chart related to an example of a distribution of sales proceeds for an embodiment where a radio station facilitates sales of media and a user is charged a commission for selling media.

FIG. 15D illustrates a block diagram and pie chart related to an example of a distribution of sales proceeds for an embodiment where a radio station facilitates sales of media and a user is charged a flat-fee for selling media.

FIG. 16 illustrates one embodiment of a webpage displaying an example of a report generated for a user.

### DETAILED DESCRIPTION

Systems and methods which represent one embodiment of an example application of the invention will now be described with reference to the drawings. Variations to the systems and methods which represent other embodiments will also be described.

Some of the figures and descriptions relate to an embodiment of the invention wherein the environment is that of the Internet. The present invention is not limited by the type of environment in which the systems and methods are used. The systems and methods may be used in other environments, such as, for example, a computer network, the World Wide Web, a private network for a hospital, a broadcast network for a government agency, an internal network of a corporate enterprise, an intranet, a local area network, a wide area network, a wired network, a wireless network, and so forth. It is also recognized that in other embodiments, the systems and methods may be implemented as a single module, a plurality of modules, and/or implemented in conjunction with a variety of other modules and the like.

As used herein, the term “media” refers to creative content of any type, including, but not limited to, recorded sound, recorded video, text, still images, computer code, artwork, a drawing, a painting, a lithograph, a reproduction, a photograph, music, a soundtrack, a musical score, a lyrical work, sheet music, an audio recording, a video, a movie, a short film, a television program, an audio/visual recording, attire, fashion, and a wearable article. By way of example only, some of the embodiments disclosed herein are described with reference to music and musicians. These embodiments are not limited to the type of media discussed and apply generally to all media.

Additionally, the disclosed embodiments are described with reference to users that connect to the system. The users that connect to the system include, but are not limited to, consumer users, industry users, producer users, and media distribution center users. In one embodiment, a “consumer user” is an individual, a group of individuals, or an organization who wishes to purchase media associated with a producer user. A “producer user” is an individual, a group of individuals or an organization that creates media or represents an individual, group of individuals, or an organization that creates media. For example, a producer may be any one of a musician, a band, an artist, an educational institution, a governmental agency, a fashion designer, a talent agent, a record label, a. production house, an emerging artist, an established artist, a commercial label, a producer, a creator, an independent artist, a traditional media creator, a consortium, an organization, a filmmaker, and an amateur media creator. An “industry user” is an individual, a group of individuals, or an organization that is interested in demographic information, sales trends, metrics and other data related to the sales and/or popularity of media or groups of media. For example, an industry user may be any one of an artist, a band, a talent agent, a radio station, a concert venue, a record producer, a marketing or advertising firm, a museum, and a media distribution center. A “media distribution center user”, is a user associated with an entity capable of broadcasting or otherwise transmitting media. For example, a media distribution center may be any one of a terrestrial radio station, a satellite radio station, an internet streaming radio station, a terrestrial television station, a cable television station, a satellite television station, an internet streaming media station, an on-demand media station, and an internet website. As used herein, a “media distribution center” is sometimes referred to as a “radio station” by way of example only; the disclosed embodiments should not be limited to such contexts.

Though references to particular types of users are made herein, the disclosed embodiments should not be limited to a particular user type. Rather, references to user types should be interpreted generally and interchangeably. Additionally, a user can be of more than one type. For example, a musician may be both a consumer user and a producer user, and a talent agent may be a producer user and an industry user.

### I. System Architecture

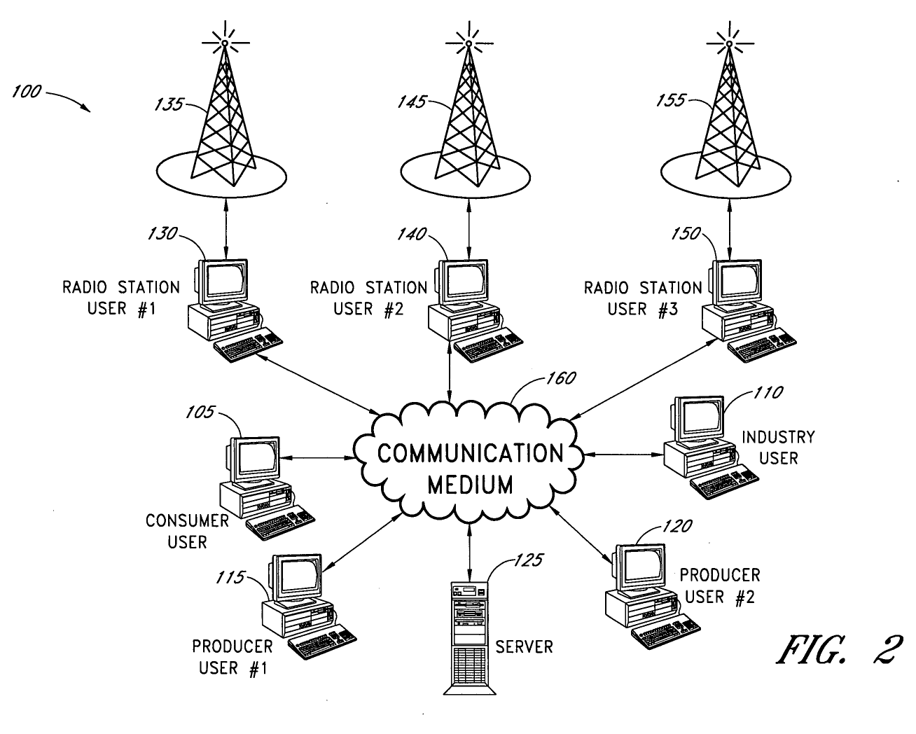

FIG. 2 is a high-level system diagram illustrating one embodiment of a system for marketing and selling media. Users 105, 110, 115, 120, 130, 140, 150 connect to a server (referred to herein as a “host device”) 125 over a communication medium 160.

The communication medium 160 may advantageously facilitate the transfer of electronic content. In one embodiment, the communication medium 160 includes the Internet. The Internet is a global network connecting millions of computers. The structure of the Internet, which is well known to those of ordinary skill in the art, is a global network of computer networks utilizing a simple, standard common addressing system and communications protocol called Transmission Control Protocol/Internet Protocol (TCP/IP). The connections between different networks are called “gateways”, and the gateways serve to transfer electronic data worldwide.

In one embodiment, the Internet includes a Domain Name Service (DNS). As is well known in the art, the Internet is based on Internet Protocol (IP) addresses. The DNS translates alphabetic domain names into IP addresses, and vice versa. The DNS is comprised of multiple DNS servers situated on multiple networks. In translating a particular domain name into an IP address, multiple DNS servers may be accessed until the domain name translation is accomplished.

One part of the Internet is the World Wide Web (WWW). The WWW is generally used to refer to both (1) a distributed collection of interlinked, user-viewable hypertext documents (commonly referred to as “web documents” or “web pages” or “electronic pages” or “home pages” or “HTML pages”) that are accessible via the Internet, and (2) the client and server software components which provide user access to such documents using standardized Internet protocols. The web documents are encoded using Hypertext Markup Language (HTML) and the primary standard protocol for allowing applications to locate and acquire web documents is the Hypertext Transfer Protocol (HTTP). However, the term WWW is intended to encompass future markup languages and transport protocols which may be used in place of, or in addition to, HTML and HTTP.

The WWW contains different computers which store electronic pages, such as HTML documents, capable of displaying graphical and textual information. Information provided by the document server computer 150 on the WWW is generally referred to as a “website.” A website is defined by an Internet address, and the Internet address has an associated electronic page. Generally, an electronic page may advantageously be a document which organizes the presentation of text, graphical images, audio and video.

In addition to the Internet, the communication medium 160 may advantageously include network service providers that offer electronic services such as, by way of example, Internet Service Providers (hereinafter referred to as ISP). An ISP or other network service provider may advantageously support both dial-up and direct connection in providing access to various types of networks. An ISP can be a computer system which provides access to the Internet. Generally, the ISP is operated by an ISP company. Examples of ISP companies include America On-line®V, the Microsoft Network®, Network Intensive®, and the like. Typically for a fee, these ISP companies provide a user a software package, username, password, and access phone number. Using this information, users 105, 110, 115, 120, 125, 130, 140, 150 can connect to the ISP and access the Internet. Those of ordinary skill in the art will realize that the ISP is optional and a computer can advantageously execute software programs providing direct access to the Internet. In this instance, the computer may be connected directly to the Internet.

In one embodiment, the host device 125 acts as a central storage location for media files available on the system. In other embodiments, media files are distributed throughout the system. In yet other embodiments, media files are stored locally on user devices (for example, devices 105, 110, 115, 120, 130, 140 and/or 150).

In the depicted embodiment, producer users 115, 120 upload media files to the host device 125 via the communication medium 160. The host device 125 stores the media files and displays representations of the files on an Internet website. A consumer user 105 can then access the website to preview and/or purchase a media file. In some embodiments, the previewing and/or purchasing habits of consumer users 105 are tracked by the host device 125 and reported to an industry user 110 according to parameters provided by the industry user 110.

Additionally or alternatively, the system for marketing and selling media may be accessed via a media distribution center user such as, for example, a radio station user 130, 140, 150 that transmits a broadcast to listeners using a distribution/transmission channel. 135, 145, 155. In one embodiment, the media distribution center embeds an interface to the host device 125 in the medium distribution center's website. The website is configured to permit a consumer user to preview and/or purchase media a producer user has uploaded using the media distribution center's website. For example, a consumer user 105 may purchase a song featured by a radio station directly from the radio station's website. Additionally, new and emerging artists may also submit their music to the radio station for broadcast consideration. Further, the radio station can also track the preferences of its listeners in order to dynamically create playlists oriented toward the radio station's target demographic.

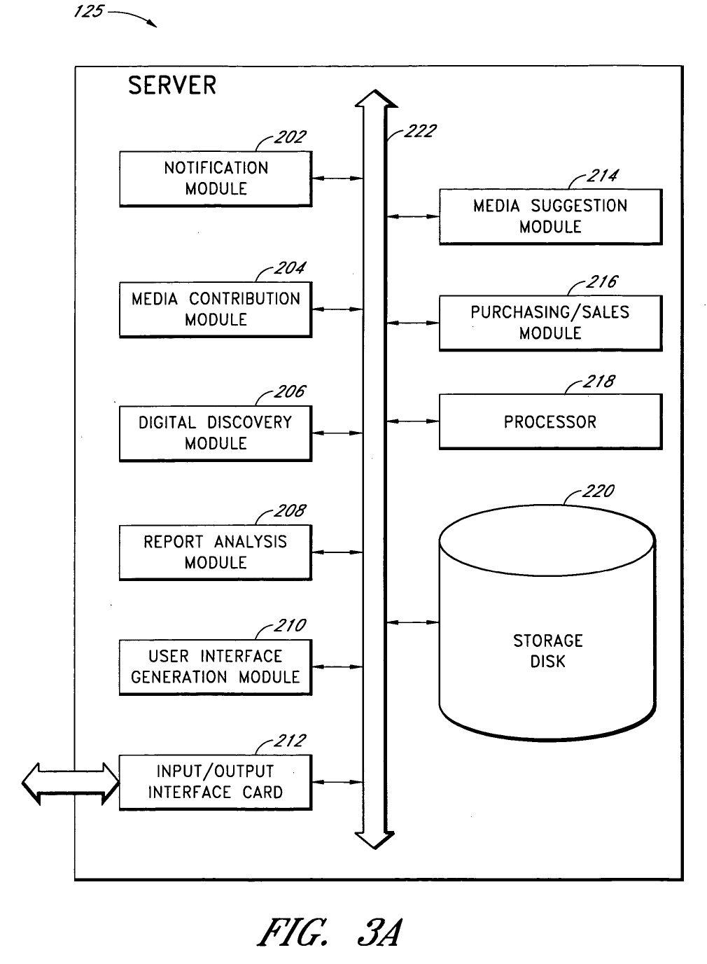

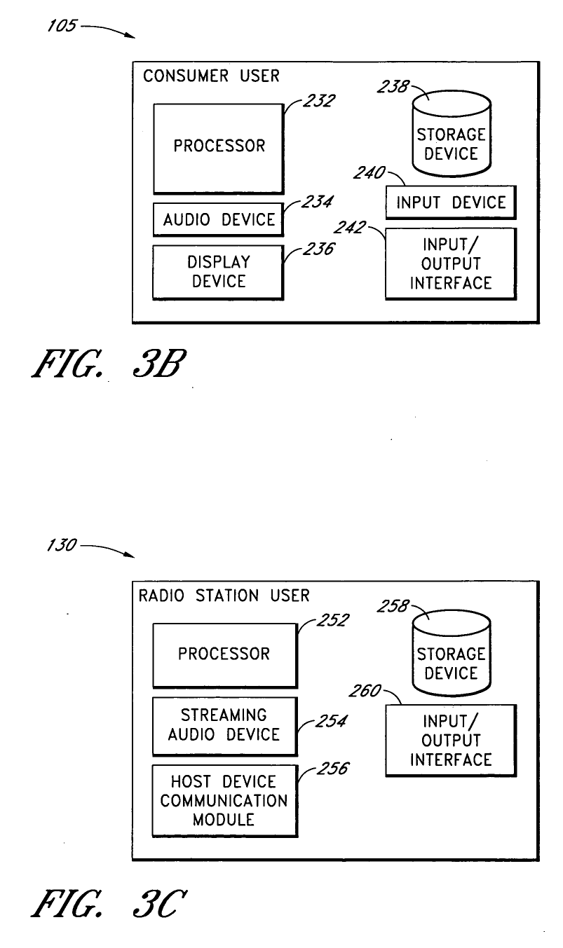

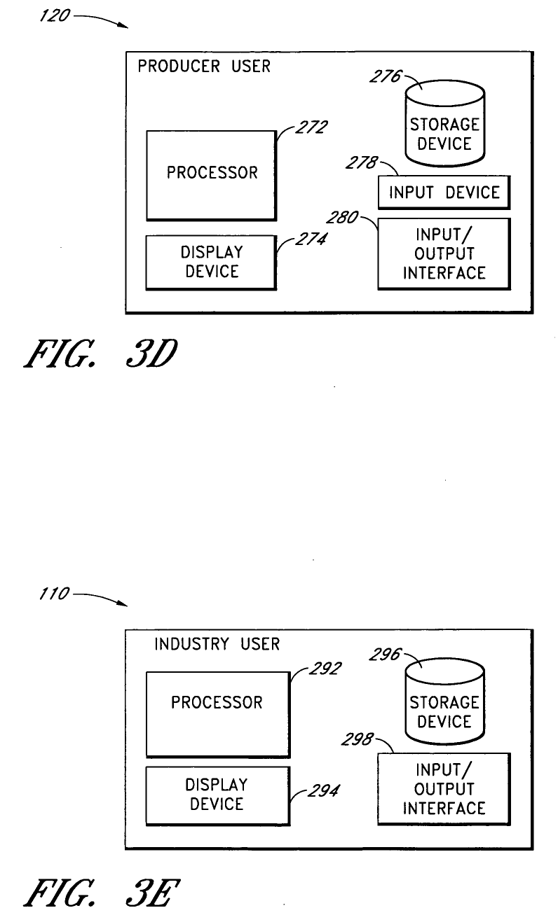

FIG. 3A illustrates one embodiment of a server or “host device.” The host device 200 comprises several components including but not limited to, a notification module 202, a media contribution module 204, a digital discovery module 206, a report analysis module 208, a user interface generation module 210, a media suggestion module 214, a purchasing/sales module 216, a processor 218, a storage disk (referred to herein as a “storage device” or “storage unit”) 220 and an input/output interface card 212. In some embodiments, the host device may comprise only a subset of the depicted components or may comprise components that are not shown in FIG. 2A.

In the embodiment shown, the components are in communication with each other via a bus 222. In another embodiment, components communicate via dedicated channels between one or more of the components. In yet another embodiment, the components are comprised of one or more integrated circuits.

In one embodiment, the modules described above perform functions according to the following table:

| Module | Function |
|---|---|
| Notification Module (202) | Notifies users that a report or new media that satisfies the |
| | user's parameters is available |
| Media Contribution Module (204) | Receives media from users and coordinates storage on the |
| | storage device of the host device |
| Digital Discovery Module (206) | Receives parameters from a user and identifies media that |
| | satisfies the received parameters |
| Report Analysis Module (208) | Receives parameters from a user and generates a report |
| | according to the received parameters |
| User Interface Generation Module (210) | Generates a display based on inputs received from a user |
| | and from other modules |
| Media Suggestion Module (214) | Receives the previewing and/or purchasing history of one |
| | or more users and suggests media based on the history |
| Purchasing/Sales Module (216) | Receives purchasing information from a user and |
| | facilitates distribution of media to the user |

In other embodiments, more than one of the depicted modules may be implemented as a single module or a single module may be implemented as more than one module.

As used herein, the word module refers to logic embodied in hardware or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Moreover, although in some embodiments a module may be separately compiled, in other embodiments a module may represent a subset of instructions of a separately compiled program, and may not have an interface available to other logical program units.

In one embodiment, the storage device 220 stores media files available on the system. The media files are stored digitally in any one of a variety of formats. Some formats include, but are not limited to, wma, mp3, ogg, flash video, mpeg4, avi, jpeg, tiff, gif bmp, png, document, and text formats. In some embodiments, the storage device 220 may be a single physical disk. In other embodiments, the storage device 220 may comprise a plurality of physical disks in communication with one another and/or the bus 222. In yet other embodiments, the storage device 220 may be a magnetic storage medium, an optical disk, a random access memory, a hard drive, and/or a partitioned portion of a hard drive.

The input/output interface card 212 receives and transmits data to and from devices external to the host device 125.

In one embodiment, the processor 218 executes functions performed by the modules, coordinates communication between modules, processes user inputs and other inputs, and/or manages data storage and data retrieval from the storage device 220.

The processes executed by the host device 125 and/or the modules 202, 204, 206, 208, 210, 214, 216 may run on a variety of computer systems such as, for example, a computer, a server, a smart storage unit, and so forth. In one embodiment, the computer may be a general purpose computer using one or more microprocessors, such as, for example, an Intel® Pentium® processor, an Intel® Pentium® II processor, an Intel® Pentium® Pro processor, an Intel® Pentium® IV processor, an Intel® Pentium® D processor, an Intel® Core™ processor, an xx86 processor, an 8051 processor, a MIPS processor, a Power PC processor, a SPARC processor, an Alpha processor, and so forth. The computer may run a variety of operating systems that perform standard operating system functions such as, for example, opening, reading, writing, and closing a file. It is recognized that other operating systems may be used, such as, for example, Microsoft® Windows® 3.X, Microsoft® Windows 98, Microsoft® Windows® 2000, Microsoft® Windows® NT, Microsoft® Windows® CE, Microsoft® Windows® ME, Microsoft® Windows® XP, Palm Pilot OS, Apple® MacOS®, Disk Operating System (DOS), UNIX, IRIX, Solaris, SunOS, FreeBSD, Linux®, or IBM® OS/2® operating systems.

FIG. 3B illustrates one embodiment of a device used by a consumer user. In one embodiment, the consumer user device 105 includes, but is not limited to, a processor 232, an audio device 234, a display device 236, a storage device 238, an input device 240 and an input/output interface 242. The consumer user device 105 is capable of accepting query requests, payment information, and other data via the input device 240. This data can be transmitted to the host device via the input/output interface 242. Accordingly, when a user purchases media, the media is transmitted to the consumer user device 105 via the input/output interface 242 and stored in the storage device 238. Then, the user may access media stored in the storage device 238 using the input device 240. When accessed, the media is played using the audio device 234 and/or the display device 236. In other embodiments, the consumer user device 105 may comprise fewer components or components that are not depicted. In yet other embodiments, the components may perform additional functions required for interfacing with the host device 125.

FIG. 3C illustrates one embodiment of a device used by a radio station user. In one embodiment, the radio station user device 130 includes, but is not limited to, a processor 252, a streaming audio device 254, a host device communication module 256, a storage device 258, and an input/output interface 260. The radio station user device 130 is capable of interfacing with the host device 125 via the host device communication module 256. For example, the host device communication module 256 is capable of embedding the host device 125 interface in the radio station user's website. In one embodiment, media files are stored remotely on the storage device 220 host device 125. The host device communication module 256 accesses the media and streams it to listeners using the streaming audio device 254. In another embodiment, media files are stored locally by the radio station user device 130. If the media is stored locally, the streaming audio device 254 directly accesses the media from the storage device 258. In other embodiments, the radio station user device 130 may comprise fewer components or components that are not depicted. In yet other embodiments, the components may perform additional functions required for interfacing with the host device 125.

FIG. 3D illustrates one embodiment of a device used by a producer user. In one embodiment, the producer user device 120 includes, but is not limited to, a processor 272, a display device 274, a storage device 276, an input device 278, and an input/output interface 280. The producer user can select media files stored on the storage device 276 for upload to the host device 125 using the input device 278 and the input/output interface 280. Additionally, the display device 274 and the input device 278 permit a producer user to manage the producer user's profile. In other embodiments, the producer user device 120 may comprise fewer components or components that are not depicted. In yet other embodiments, the components may perform additional functions required for interfacing with the host device 125.

FIG. 3E illustrates one embodiment of a device used by an industry user. In one embodiment, the industry user device 110 includes, but is not limited to, a processor 292, a display device 294, a storage device 296, and an input/output interface 298. The industry user device 110 is capable of receiving notifications and reports from the host device 125 via the input/output interface 298. These reports and notifications can be viewed using the display device 294 and stored either permanently or temporarily on the storage device 296. Accordingly, the storage device 296 may be a hard drive, a flash memory, an SRAM, a DRAM, or an optical storage medium. In other embodiments, the industry user device 110 may comprise fewer components or components that are not depicted. In yet other embodiments, the components may perform additional functions required for interfacing with the host device 125.

### II. Account Creation

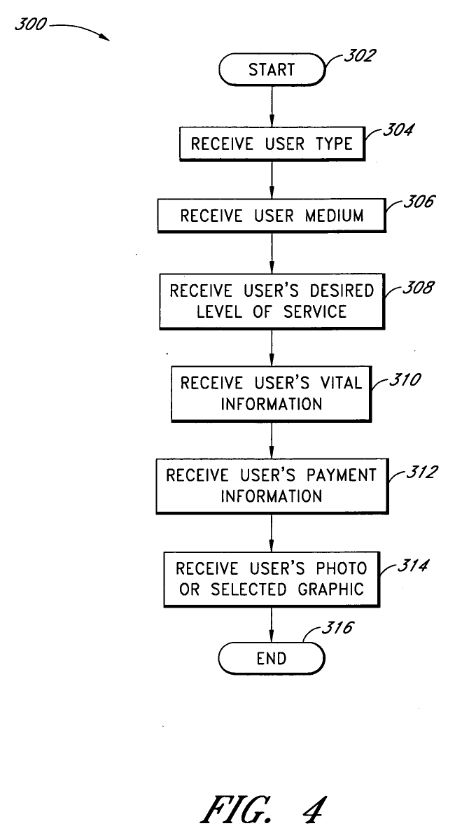

FIG. 4 illustrates one embodiment of a flowchart of operations for creating an account. In one embodiment, a user must have an account on the system before gaining access to the system. In another embodiment, an account permits a user to use one or more of the system's features. The account creation operation 300 starts 302 by receiving the user type 304. The user type may be at least one of, but is not limited to, a consumer user, a producer user, an industry user, and a media distribution center user. In some embodiments, a user account may be for only one type. For example, a user desiring a consumer user account and an industry user account would have to create two accounts, each with a different user ID. To create two accounts, the steps of the account creation operation 300 are repeated twice. In other embodiments, a user may have one account for two or more types. For example, in step 304, the user can create a consumer user account and an industry user account represented by a single user ID. In these embodiments, the user may switch between account types by selecting a button, a tab or other selectable area on the user interface. Alternatively, all features associated with the user's account types may be displayed in a single view.

After the user type has been selected 304, the process 300 receives the user's medium 306. Examples of a medium include, but are not limited to, music, art, fashion, video, photography, painting, and sculpture. In one embodiment, the medium specified in step 306 limits the scope of media files available for the user to sell, preview, purchase or receive reports on. For example, if a producer user is both a painter and a musician, the producer user will be required to create two separate accounts, one music-based account and one art/painting-based account, in order to sell in both mediums. In another embodiment, a single user ID can correspond with two or more mediums. In yet another embodiment, the medium specified dictates featured producer users that most interest the user. For example, a consumer user that specifies fashion as a medium may be presented with fashion related articles or a list of the most popular fashion designers.

In one embodiment, a user need only specify a medium if they select a producer user or industry user account type. In another embodiment, a user needs to select a user medium irrespective of the chosen user type. In yet another embodiment, specifying a medium is optional.

Next, in step 308, the operation 300 receives the user's desired level of service. The level of service determines the features available to the user. For example, a producer user may be presented with levels of service that provide various options relating to the number of media files available for sale, whether the user is limited to selling work in only one type of medium, the duration of the user's account, and whether the user has to pay a flat-fee or a commission. Similarly, an industry user may be presented with levels of service that provide various options relating to the frequency with which reports can be received, how long reports can be viewed, the number of parameters used to generate a report, the method for notifying the user that the report is available for viewing, and whether the cost of service is to be paid as a fixed-fee or on a per-report basis. In some embodiments, the level of service corresponds to the charge for using the service. For example, a user may have a choice there may be varying fixed-fees and/or more than one varying commission rate.

In step 310, the account creation operation 300 receives the user's vital information. Vital information may include, but is not limited to, the user's name, the artist name, address, phone number, email address, website, self-description, genre, subgenre, interests, and so forth. In one embodiment, the user is required to submit at least a name, mailing address, and phone number in order to create an account.

Next, the system receives the user's payment information 312. The payment information may include at least one of on-line escrow account information, on-line bank account information, credit card information, debit card information, checking account information, money-market account information, savings account information, a mailing address, and so forth. The payment information is used to charge the user for purchases the user makes and to credit a user when the user sells media. For example, a consumer user is charged for media purchases; an industry user is charged for reports; and depending on the level of service chosen, a producer user is charged for using the system and/or credited for sales.

In step 314, the operation 300 receives the user's photo or a selected graphic/logo. The photo, graphic, or logo is associated with the user and appears in proximity to the user's profile. In some embodiments, a user cannot create an account unless she has submitted a photo, graphic or logo.

After the system receives the information from steps 304 to 314, the account creation operation 300 ends 316 and the user's profile is created. In some embodiments, the user's profile may include some or all of the user type, the medium, the desired level of service, vital information, and the user's photo, graphic or logo.

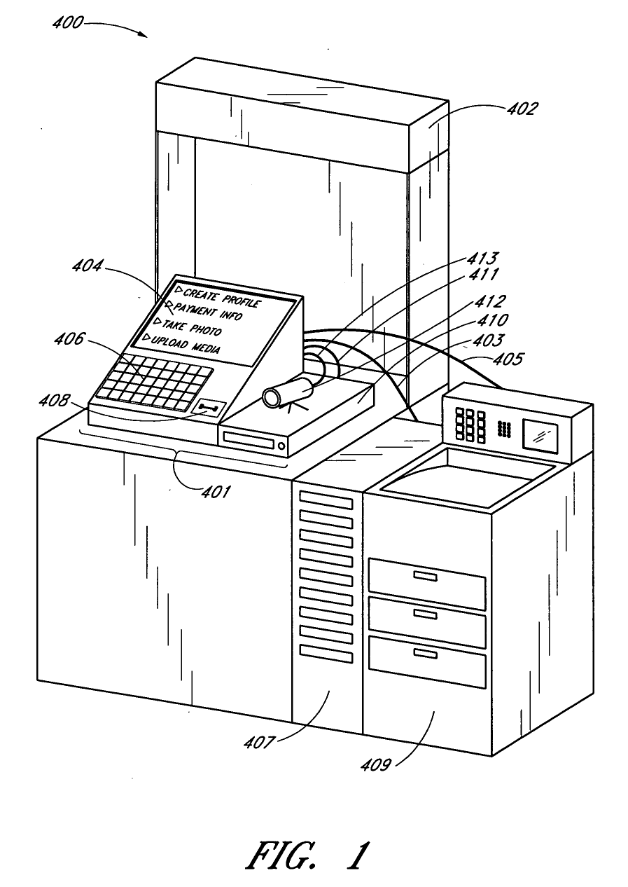

FIG. 1 illustrates one embodiment of a kiosk capable of housing a terminal for receiving demographic data and media. The kiosk 400 is a convenient way for users to create a profile, submit demographic data, submit media, purchase media, receive reports, create queues/playlists and/or sell media. For example, the kiosk 400 may be set up at a trade show, convention, or industry event to permit producer users to submit their media for consideration by media distributors, concert promoters, venue owners, industry executives, and/or others. The kiosk 400 is comprised of a booth 402 that houses a terminal 401, a mass media duplicator 407, and a printer 409. The terminal is comprised of a display 404, a user input device 406, a magnetic card reader 408, a drive 410, and a camera 412. In one embodiment, the display 404 is used to instruct a user on how to create an account and shows user input as it is entered via the user input device 406. The user input device 406 may be a keyboard or other conventional input device such as a mouse, trackball, light pen, or microphone.

The terminal 401 also permits the user to rapidly enter payment information via the magnetic card reader 408. The magnetic card reader 408 is in communication with the terminal 401. For example, a user may slide a debit card or credit card into the reader 408 to specify their payment information. In another embodiment, the terminal 401 comprises a device which can read a bank check. For example, the terminal 401 can receive account and routing numbers associated with the user's bank account.

The camera 412 is connected to the terminal 401 via cable 413. The camera 412 may be a still camera or a video camera capable of capturing the user's image. For example, when prompted on the display 404, the user can adjust the position of the camera 412 in order to take a photograph. In some embodiments, the image received by the camera 412 is shown on the display 404.

The drive 410 is connected to the terminal 401 via cable 411. The drive 410 is used for receiving media files from the user. The drive 410 may be capable of reading CDs, DVDs, floppy disks, Flash memories, USB memory sticks, and so forth. In one instance, a producer user may upload music associated with his profile by placing a CD containing an audio recording of his work in the drive 410.

The duplicator 407 is connected to the terminal 401 via a cable 403. The duplicator 407 is used to duplicate music provided by the user. It is capable of concurrently creating multiple copies of media. For example, the duplicator 407 shown in FIG. 1 is capable of creating a six copies of a CD or DVD inserted in the drive 410. In other embodiments, the duplicator 407 is capable of creating CDs or DVDs that store playlists comprising media titles from more than one user. In yet other embodiments, the duplicator 407 is capable of creating multiple CDs or DVDs at the same time.

The printer 409 is connected to the terminal 401 via cable 405. The printer is used to generate reports associated with the media inserted into the drive 410. The contents of the reports are described in more detail below. In other embodiments, the printer 409 can be used to print visual media such as photographs.

It will be appreciated by one with ordinary skill in the art that the kiosk 400 can be configured to transmit information to the owner of the kiosk 400. For example, a music talent agent may set up a kiosk 400 to receive information and/or media from prospective clients. After all prospective clients have entered their information, the data can be compiled, sorted, organized, or otherwise manipulated to make review of the information and/or media convenient and time efficient.

### III. Media Upload

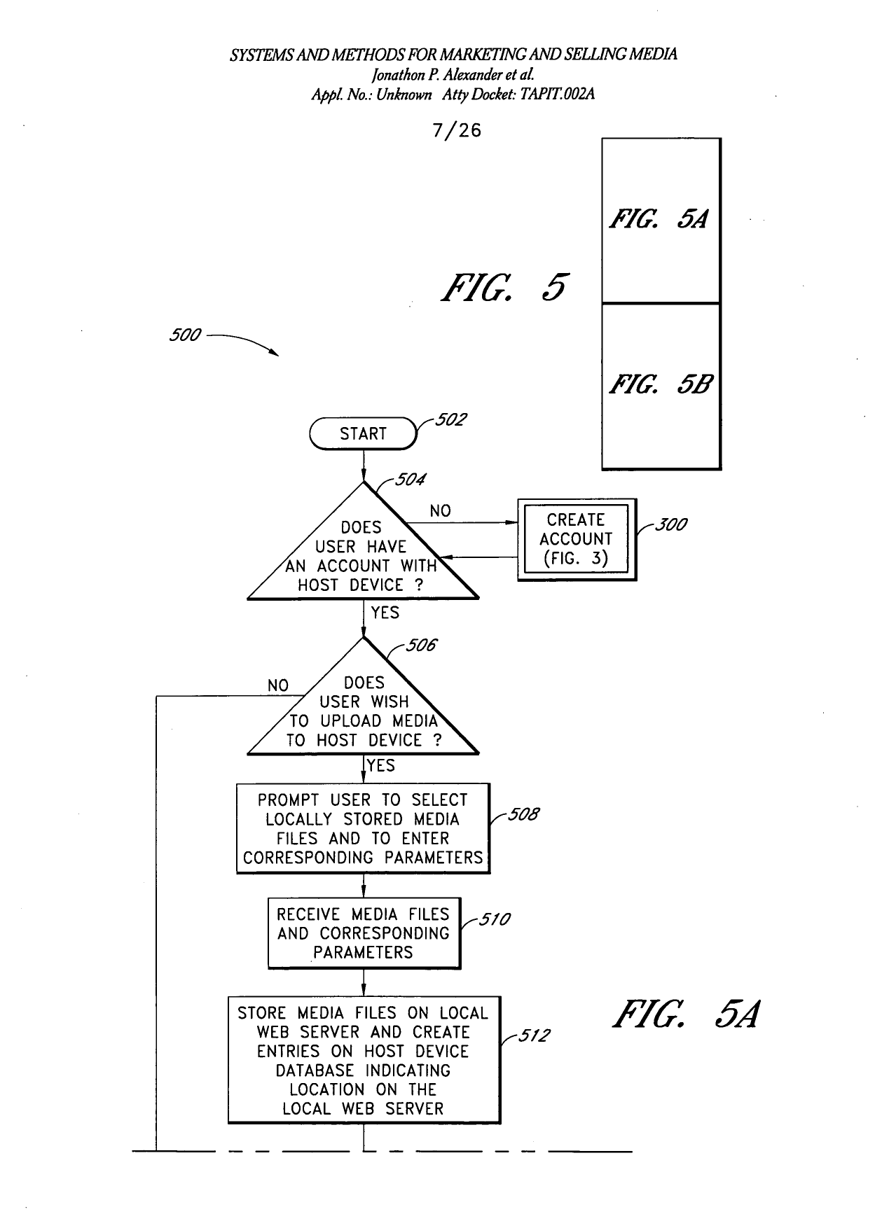

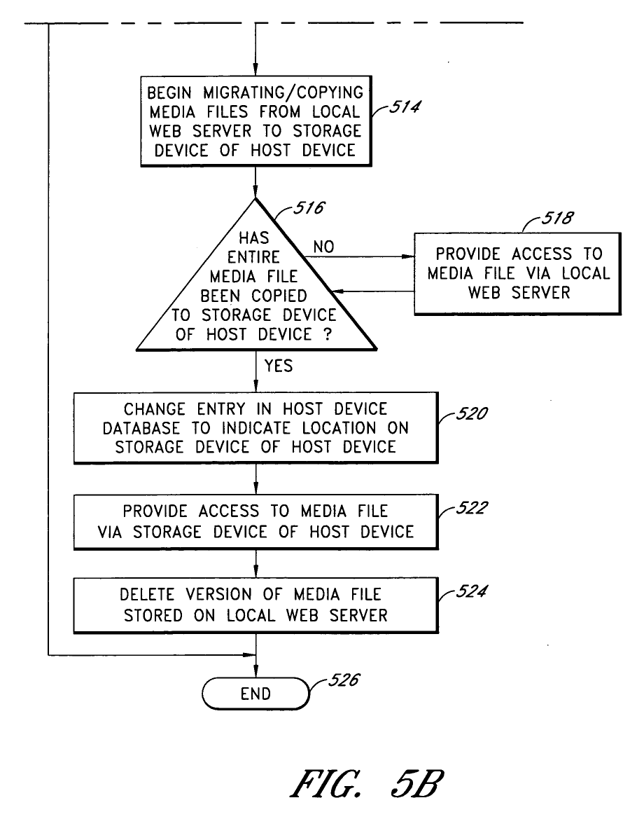

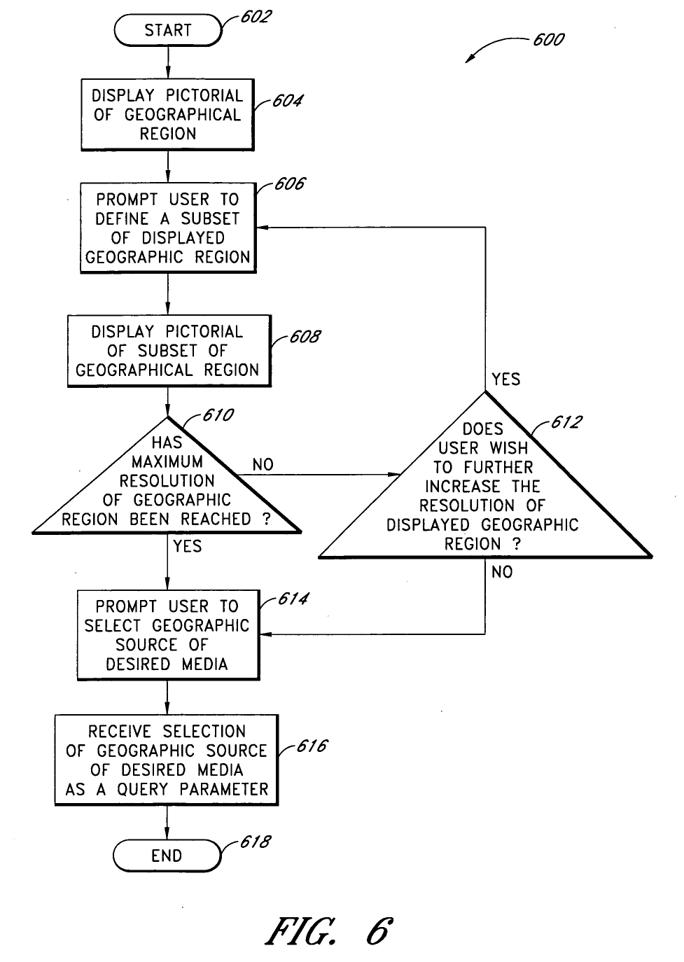

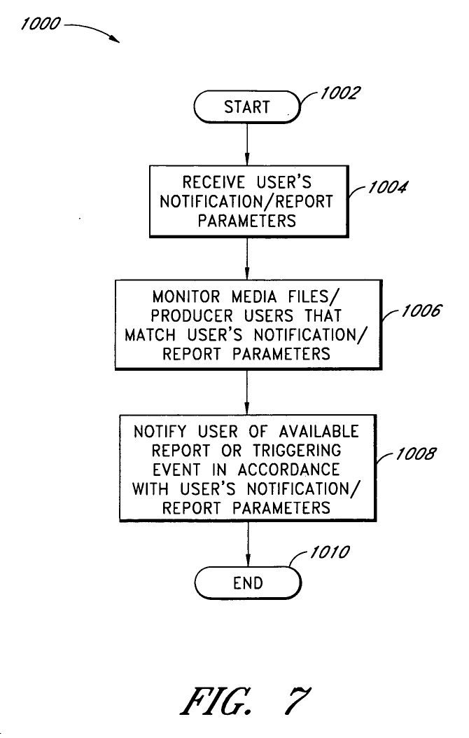

FIGS. 5, 5A, and 5B illustrate one embodiment of a flowchart of operations for uploading media. In one embodiment, uploaded media is staged in order for the media to become quickly available to those wishing to view the media. Rather than processing the uploaded data for storage on a central storage device, the media is first stored locally on a web server. While the copy is stored on the web server, the data is available to those connected to the system. Concurrently, a copy of the data is created on a central storage device such as a host device. After the media file has been copied to the host device, a user accesses the media using the copy of the media file stored on the host device. Staging the upload in this manner can provide faster access to the media files. For example, staging circumvents the delay associated with concurrent write requests by more than one client to the storage device of the host device.

When the media upload operation 500 begins 502, decision block 504 asks whether the user has an account with the host device. If the user does not have an account, the user is prompted to create an account via the account creation process 300. In some embodiments, the user is prompted to upgrade an existing account if the level of service or the type associated with the user's account does not permit uploading data.

If the user has an account, decision block 506 asks whether the user wishes to upload media to the host device. If the user does not wish to upload media, then the media upload operation ends 526. However, if the user wishes to upload media to the host device, the user is prompted to select locally stored media file(s) 508. The media file(s) may be locally stored on any one of a hard disk, a magnetic storage medium, a CD, a DVD, an optical disk, a Flash drive, a USB memory device, and so forth. In response to the media file(s) selected for upload, the media upload operation prompts the user to enter parameters that correspond to each media file 508. The parameters may include the artist name, the compilation name (for example, album name), the year the media was created, the price, the geographic source of the medium, a subject, a description, a genre and a subgenre. In one embodiment, the system will not accept a media file upload if certain minimum parameter information has been entered. For example, an upload may be refused if the price of the media has not been entered.

As used herein, a “genre” includes a broader class of media than a “subgenre.” In some embodiments, every genre may have one or more subgenres. For example, a “rock music” genre may include subgenres such as alternative, pop, and hard. Accordingly, these subgenres may be represented as Rock(Alternative), Rock(Pop), and Rock(Hard). In other embodiments, only some or none of the genres comprise subgenres.

The parameters associated with a media file and are related to query parameters. In one embodiment, a user specifies one or more parameters using a drop-down menu that provides a list of possible parameter values. In another embodiment, the host device assigns parameters to the media file. These parameters include, but are not limited to, an upload time/date, a ranking, the user's name, the user's total sales volume, and other metrics. In yet another embodiment, a user specifies one or more parameters by typing the parameter value. A person with ordinary skill in the art will appreciate that the system may be further configured to reformat a parameter value typed by a user to conform to nomenclature used by query functions, storage databases, and modules of the system such as the digital discovery module.

Next, the media files and corresponding parameters are stored locally on the web server that accepted the file upload 512. In one embodiment, entries associated with the media files are created in a database located on the host device 512. An entry contains information about the media file (for example, some or all of the parameters associated with the media file) and an address. When the file is initially uploaded, the address indicates the location of the media file on the storage device of the web server.

In step 514, the process 500 begins to create a copy of the media file on the storage device of the host device. Then, decision block 516 asks whether the entire media file has been copied to the storage device of the host device. If the copy operation is not complete, the media file is accessed using the storage device of the local web server 518. For example, preview and/or purchase requests are serviced using the storage device of the local web server.

However, when the copy operation is complete, the address stored in the entry for the media file is revised to reflect the media file's new storage location on the storage device of the host device 520. After the revision to the entry is complete, access to the media file is granted via the storage device of the host device 522. For example, preview and/or purchases requests are service using the storage device of the host device. Additionally, the process 500 deletes the original copy of the media file stored by the web server to make room for subsequent uploads. In some embodiments, the copy on the web server is not deleted. Preserving copies on the local web server achieves the benefits of mirroring. For example, if the storage device of the host device is temporarily unavailable or experiences a permanent failure, media files can be accessed via the local web servers.

### IV. Digital Discovery

One aspect of this invention is digital discovery. In one embodiment, digital discovery includes single, continuous, or repetitive stored or derived queries, executed against a data store of media-related elements. A digital discovery operation serves to identify and/or extract media files of interest from a population of media files. Embodiments of digital discovery include, but are not limited to, a media query, automated playlists, and queued playlists. Theses embodiments and associated variations to digital discovery are discussed below.

a. Media Query

The system for marketing and selling data permits a user to execute queries on the media files stored by the system. To execute a query, the system receives query parameters from a user's input or by an automated process. The query parameters are then compared against the parameters associated with each media file that comprises the population of media files. In some embodiments where the query parameters may limit the number of returned media files, comparison of the query parameters against the media file parameters stops when the appropriate number of matching media files have been returned. In other embodiments, where the user enters query parameters in a format different from the stored media file parameters, the system reformats the query parameters to a compatible format before executing the comparison against media file parameters.

The query parameters can include, but are not limited to, the user's name, the artist name, the user's or artist's address, the user's or artist's phone number, the user's or artist's email address, the user's or artist's website, a self-description, a genre, a subgenre, a description of interests, a compilation name (for example, album name), the year the media was created, copyright information, a price, a subject, and the geographic source of the media.

FIG. 6 illustrates one embodiment of a flowchart of operations for specifying the geographic source of media. The media query operation 600 begins 602 by displaying a pictorial representation of a geographic region 604. The geographic region may be a continent, country, state, locality, neighborhood, province, city, municipality, county and so forth. Next, a user is prompted to define a subset of the displayed geographic region 606, a “subregion.” The user may define the subregion by typing in the name of the subregion, tracing the subregion, or selecting a subregion (for example, clicking on the subregion). In response, the media query operation 600 displays a pictorial of the subregion 608. In some embodiments, the subregion is displayed by enlarging a portion of the displayed region. In other embodiments, the subregion is displayed by rendering a more detailed portion of the region.

Next, decision block 610 asks whether a maximum resolution of the geographic region has been reached. Alternatively, the decision block 610 may ask whether a subregion within the subregion may be defined. If the maximum resolution has not been reached, decision block 612 asks whether the user wishes to further define a subregion within the displayed subregion. If the user desires to further define a subregion, the operations in steps 606, 608, and 610 are repeated until the user no longer wishes to further define a subregion or until the maximum resolution of the geographic region has been reached.

Then, in step 614, the user is prompted to select a geographic source of the desired media. In one embodiment, the user selects the geographic source of the media from a list of locations that appear within the displayed subregion. In another embodiment, the user selects the geographic source by tracing or bounding the region using a mouse or trackball. In yet another embodiment, the geographic source is defined as the displayed subregion. After the user has selected a geographic source, the media query operation 600 receives the geographic source as a query parameter 616 before ending 618.

b. Notification and Report Generation

FIG. 7 illustrates one embodiment of a flowchart of operations for providing a notification to a user and/or generating a report for a user. In one embodiment, the notification feature is used to indicate to a user when media files that match the user's preferences or entered parameters have been added to the system. In another embodiment, the notification feature is used to indicate to a user when a report is available for the user to view. A report is a representation of metrics and/or parameters associated with the media or a portion of the media stored by the system. For example, the report may indicate which artists or titles have the highest sales volume, which artists or titles have the most profile views, which artists or titles have the most previews without purchase, which artists have purchasers that fall within a target demographic, which artists are most popular amongst teenagers from the Midwest, which artists or titles would most appeal to a 47 year old woman from Seattle, Wash., and so forth.

The report can be embodied in various forms including a table, a list, alphanumeric text, a summary, a graph, a picture, and so forth. One example of a report is illustrated in FIG. 16. The report may list artists, albums, titles, sales, units sold, and other parameters or metrics.

The notification/report generation operation 1000 begins 1002 by receiving the user's notification/report parameters 10047. In one embodiment, the notification/report parameters include parameters associated with media files stored by the system. As discussed above, there are many parameters that may be associated with media files. The operation 1000 may also receive 1004 parameters associated with the desired frequency of notification or report generation, target demographic information, and triggering events such as media release dates, concert dates, and so forth.

In step 1006, media files and/or producer users that match the user's specified parameters are monitored. In one embodiment, media files and/or producer users are monitored by executing a query with the parameters on a periodic basis. In another embodiment, media files and/or producer users are monitored on a continuous basis by executing a looping query or a query that is executed on every new file added to the system.

Next, the user is notified if a report is available to view, if files matching the user's parameters have been found, or if a triggering event has occurred 1008. The notification and/or the report may be transmitted to a website, a mobile telephone, a personal digital assistant, an email account, a voicemail, a pager, a fax machine, or a mailbox. In another embodiment, a notification is generated on a periodic basis, the frequency of which may or may not be specified by the user.

c. Automated Playlist

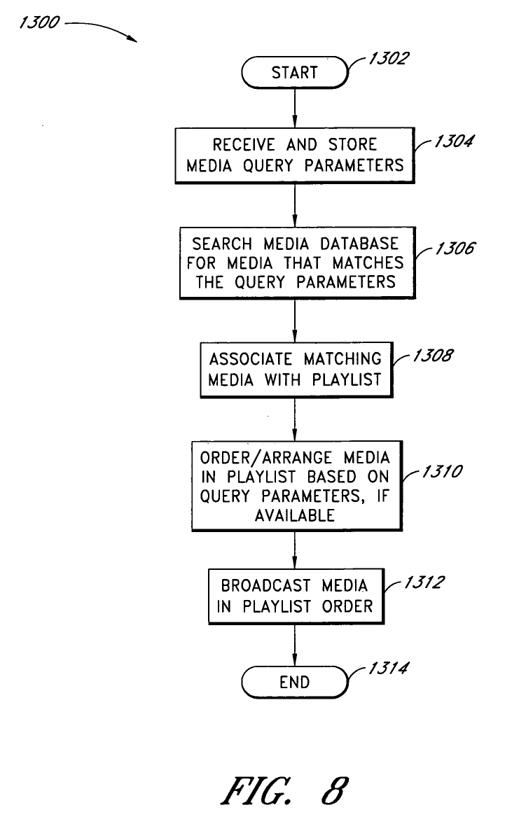

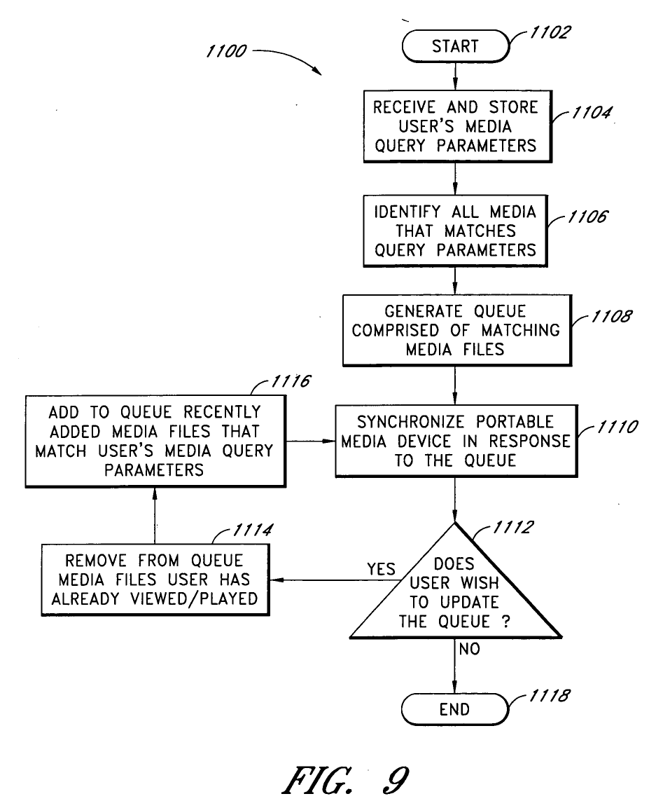

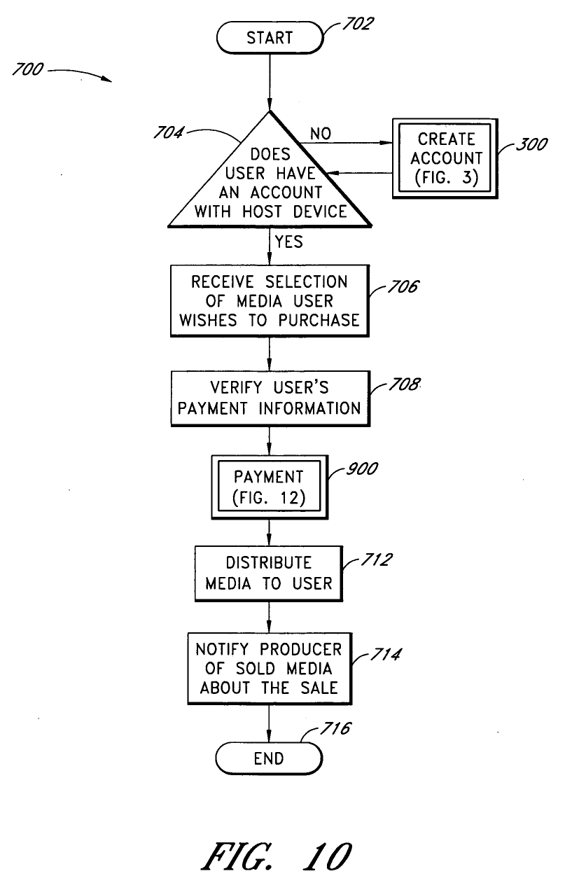

FIG. 8 illustrates one embodiment of a flowchart of operations for creating an automated playlist. The automated playlist feature can be used by media distribution centers for creating a list of titles to be played to its listeners, viewers, and/or subscribers. Such a feature may assist media distribution centers reduce costs and time by eliminating the need for personnel to handpick each title that will be played. For example, a media distribution center can create a playlist of the top 100 selling titles almost instantaneously using the automated playlist feature. Additionally, the automated playlist can increase the chances that relatively obscure or unknown titles are played. For example, new or emerging artists that are beginning to receive recognition in Los Angeles can be automatically selected for play in New York, thereby increasing the exposure of the artists.

The automated playlist operation 1300 begins 1302 by receiving and storing media query parameters 1304. As discussed above, the query parameters cover a wide variety of characteristics associated with the media files stored by the system. These parameters may also include sales, volume, ranking, popularity and other information. Additionally, the user may specify parameters such as the “top 25” titles or “top 100” titles and/or sequence preferences (for example, a random ordering or ascending order by ranking).

Next, a query is executed on the database of media files using the received parameters 1306. Then, the media files that satisfy the parameters, “matching media files,” are associated with a playlist 1308. In one embodiment, a playlist comprises a list of addresses indicating the storage locations of the media files included in the playlist. In another embodiment, a playlist comprises a copy of the matching media files that are stored either locally or remotely from the user. In yet another embodiment, a playlist comprises a list of more than one playlist.

In step 1310, the entries in the playlist are ordered according to the preferences specified by the user. In one embodiment, if the user has not specified a preferred ordering, the entries in the playlist are played in a random order.

Next, the automated playlist operation broadcasts the media titles in response to the generated playlist 1312. In another embodiment, the automated playlist operation transmits the playlist to a media distribution center for broadcast. In yet another embodiment, the playlist is transmitted to a computer or a personal media device.

In another embodiment, the automated playlist operation generates a playlist for media titles to be played in a on-line or virtual community environment such as, for example, a multi-player video game, a chat room, a bulletin board service, a discussion forum, a virtual reality environment, a website, and a blog. In these environments, media played in the on-line virtual community environment may be bought by participants using a “purchase media” feature. Purchasing in this environment operates similarly to the embedded interface in a radio station user's website (described below). For example, a user may purchase media from within the virtual community environment without substantial redirection to another website or webserver. Accordingly, the “purchase media feature” creates the feeling to a user that the purchase is completed by a host/creator of the virtual community environment.

Additionally, the automated playlist operation 1300 of FIG. 8 should not be limited to the order of steps as depicted. Rather, the operation 1300 can be implemented in various ways. For example, an individual with ordinary skill in the art will appreciate that the automated playlist operation 1300 can be modified such that the operation of step 1310 occurs concurrently with the operation of step 1308. Additionally or alternatively, the operation of step 1310 may occur concurrently with the operation of step 1312.

d. Queued Playlist

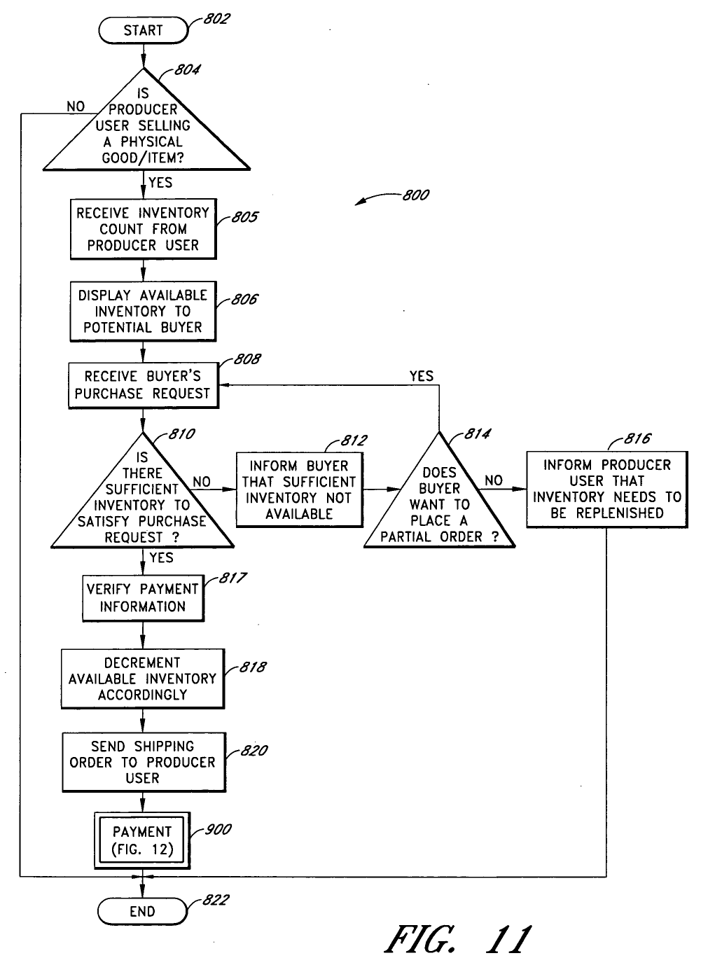

FIG. 9 illustrates one embodiment of a flowchart of operations for creating a queued playlist. A queued playlist operation 1100 is directed to users who wish to keep up to date with new music that matches their preferences. For example, a hip-hop music talent agent located in Detroit can use the queued playlist feature to keep abreast of new hip-hop titles generated by Detroit musical acts. When the talent agent uses the queued playlist feature for the first time, the user enters preferences related to desired artists and/or titles. In response, matching titles are entered into a queue. The titles in the queue may be downloaded to a portable media player or a computer. After the talent scout has listened to a portion of the titles in the queue, the queued playlist operation is configured to (a) remove titles that the talent scout has already listened to and (b) add matching titles that have recently been added to the system.

The queued playlist operation 1100 begins 1102 by receiving and storing a user's media and query parameters 1104. As discussed above, these parameters include parameters associated with the media files stored by the system. The parameters may also include update preferences such as updating when the personal audio device is connected to a computer, updating at a specified frequency, and/or updating when new matching media files are available.

In step 1106, the operation 1100 identifies all media files stored by the system that match the query parameters. Then, the matching media files are compiled in a playlist or a queue 1108. In some embodiments, the titles in the queue are ordered according to the date the media file was added to the system. In other embodiments, the titles in the queue are ordered according to a metric associated with the title's popularity.

Next, in step 1110, a user's portable media device is synchronized in response to the queue. In other embodiments, other types of devices are synchronized such as, for example, a computer, a website, a cellular telephone, and so forth.

Decision block 1112 asks whether the user wishes to update the queued playlist. If the user does not wish to update the playlist, the queued playlist operation 1100 ends 1118. However, if the user wishes to update the queued playlist, media files that the user has already listened to are removed from the queue 1114. In another embodiment, media files that the user has not yet listened to but has marked for removal are also removed from the queue.

In step 1116, matching media files that have been recently uploaded to the system are added to the queue. In one embodiment, a recently added media file is a media file uploaded to the system after the last time the portable media device was synchronized in response to the queue. In other embodiments, a recently added media file is a media file uploaded to the system within a specified time period.

After the files have been removed 1114 and added 1116 to the queue, the portable media device is synchronized in response to the updated queue 1110. The operations in steps 110, 112, 114, and 116 repeat until the user no longer wishes to update the queue. At that time, the queued playlist operation 1100 ends 1118.

An individual with ordinary skill in the art will appreciate that alternative implementations to create a queued playlist exist. For example, the depicted operation 1000 can be modified to allow an entry point at step 1110 for queued playlists that have already been created, to permit only additions to the queue, to permit only removals from the queue, or to permit a user to rate titles in the queue.

### V. Media Purchase and Distribution

The embodiments disclosed herein offer convenient methods for purchasing digital media and selling physical media. “Digital media” is any media that can be stored digitally such as, for example, on a computer hard drive, a Flash memory, a CD, a DVD and so forth. Examples of digital media suitable for distribution include digital images/photographs, digital recorded music, digital videos. “Physical media” is any media that is not capable of being digitally stored or media where a purchaser desires to purchase the original or a physical copy of the work. Examples of physical media include handwritten manuscripts, sculptures, paintings, analog recordings on tape or vinyl record, and master recordings. The sale and distribution of both digital and physical media are described below. Additionally, the distribution of sales revenue is also discussed.

a. Digital Media

FIG. 10 illustrates one embodiment of a flowchart of operations for selling digital media. The digital media sales operation 700 begins 702 by asking whether the user has an account with the host device 704. If the user does not have an account, the user is instructed to create an account 300. However, if the user has an account, the digital media sales operation 700 receives a selection of a media file(s) that the user wishes to purchase 706.

After the selection is received, the user's payment information is verified 708. Payment information can be verified in any number of ways including verifying whether sufficient funds are available, whether an account number belongs to the user, whether a bank or credit card has expired, and/or whether a billing name and address match. If the payment information cannot be verified or if the payment information is invalid, the user will be prevented from purchasing media until verifiable, valid payment information is received.

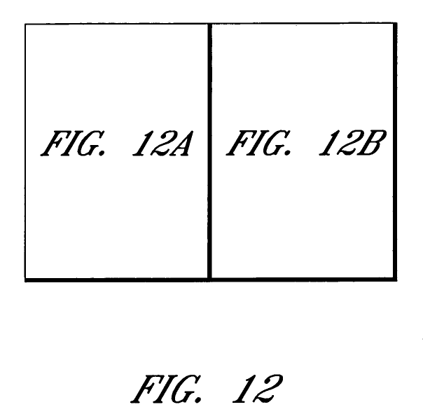

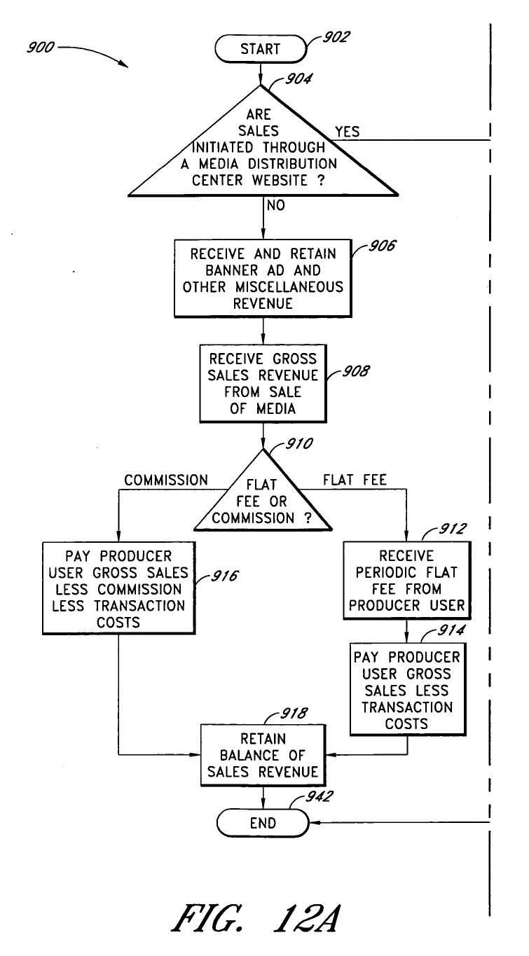

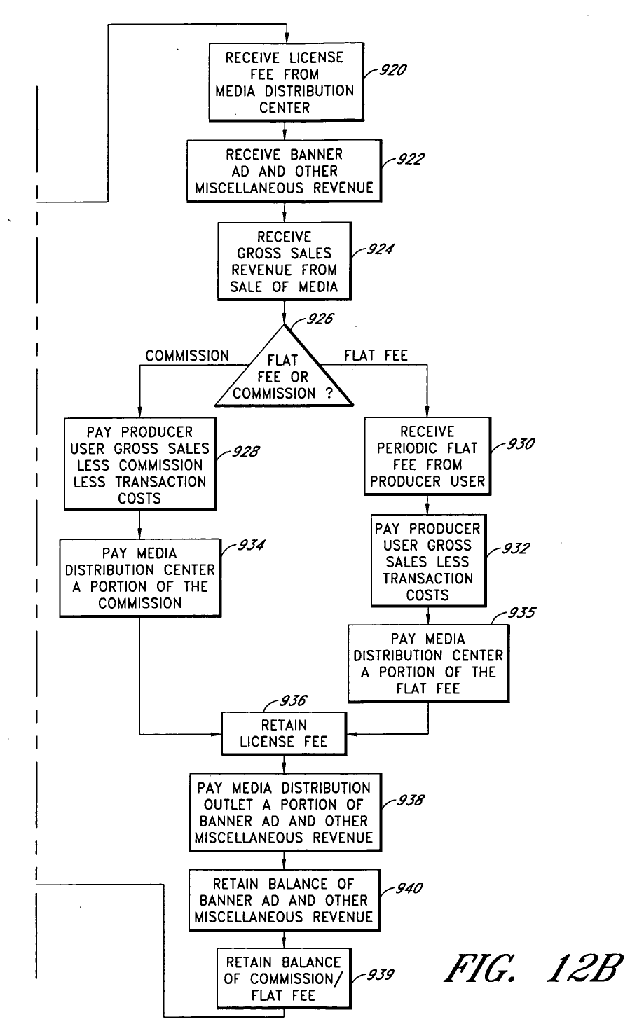

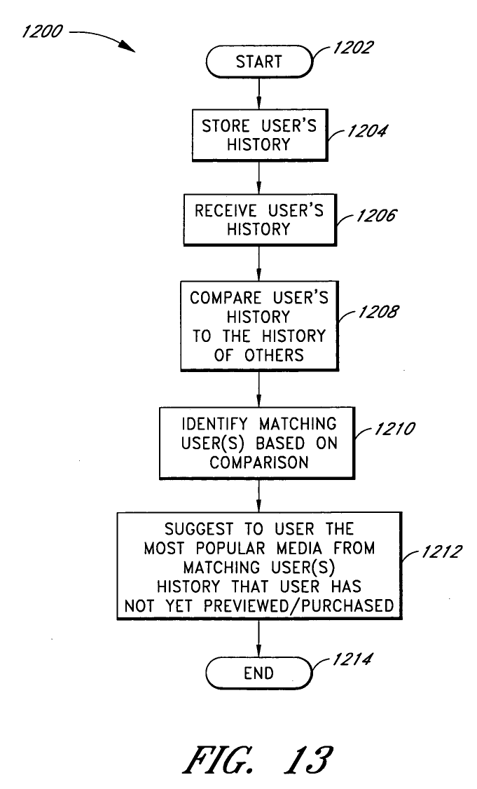

Next, payment is received and distributed according to the revenue distribution operation 900 of FIG. 12.

In step 712, the media is distributed to the user. Media distribution can include, for example, sending the media as an attachment to an electronic message, streaming the media to the user, permitting a download from a website or other portal, mailing a CD or DVD to the user's address, and/or using a file transfer protocol.

After the media has been distributed and payment has been received, the digital media sales operation 700 notifies the producer user about the sale before ending 716. In one embodiment, the digital media sales operation 700 sends a message to the producer user at predetermined sales intervals. In another embodiment, the producer user is notified of the sale by viewing the producer user's profile.

A person with ordinary skill in the art will appreciate that the operation depicted in FIG. 10 can be implemented in a variety of different ways. Examples of alternative embodiments include processes that do not contain all of the steps of FIG. 10 and processes that perform the steps of FIG. 10 in an order different than the one depicted. Additionally, the digital media sales operation 700 could incorporate a virtual shopping cart that shows a list of items a user intends to purchase and an icon representative of the virtual shopping cart. For example, a user could select the price displayed on the user interface to add an item to the virtual shopping cart without substantially altering the display. Then, if the user wants to view the virtual shopping cart, the user would select an icon representative of the virtual shopping cart.

b. Physical Media

FIG. 11 illustrates one embodiment of a flowchart of operations for selling physical media. The physical media sales operation 800 begins 802 in decision block 804 which asks whether a producer user is selling a physical good or item (for example, “physical media”). If the producer user is not selling physical media, the process ends 822. However, if the producer user is selling physical media, the process 800 receives an inventory count from the producer user 805 and the inventory available for sale is displayed to potential buyers 806.

In step 808, the operation 800 receives a buyer's purchase request. Then, decision block 810 asks whether there is sufficient inventory to satisfy the purchase request. If sufficient inventory is not available, the buyer is informed that insufficient inventory exists 812. Then, decision block 814 asks whether the buyer wants to place a partial order (for example, an order in a smaller quantity than originally requested). If the buyer does not want to place a partial order, the producer user is informed that sufficient inventory was unavailable to fill the buyer's order 816 and the process ends 822.

However, if in decision block 814, the buyer wishes to place a partial order, the process returns to step 808 and the buyer is prompted to enter a quantity less than the one previously requested. This process repeats until the buyer places an order that can be filled with the available inventory or the buyer no longer wishes to place a partial order.

However, if in decision block 810 there is sufficient inventory to satisfy the purchase request, the process verifies the buyer's payment information 817. If the payment information is verified, the available inventory is decremented in response to the quantity ordered 818. Next, a shipping order for the purchase request is sent to the producer user 820.

In step 900, payment is collected from the buyer and funds are distributed according to FIG. 12.

It is recognized that the physical media sales operation 800 of FIG. 11 can be implemented in variety of different ways and should not be limited to the embodiment depicted. For example, the physical media sales operation 800 may prevent a user from placing a purchase request for unavailable inventory. The operation 800 may also be modified to incorporate an account verification step that determines whether the user has an account with the system. Additionally, the physical media sales operation 800 could incorporate a virtual shopping cart that shows a list of items a user intends to purchase and an icon representative of the virtual shopping cart.

c. Revenue Distribution

FIGS. 12, 12A and 12B illustrate one embodiment of a flowchart of operations for distributing proceeds from the sale of media. The revenue distribution operation 900 distributes proceeds from the sale of media based on at least two considerations: (a) whether a media distribution center user facilitates media sales or if the sale initiates directly from the host device; and (b) whether the producer user selling the media has a flat-fee or a commission-based account.

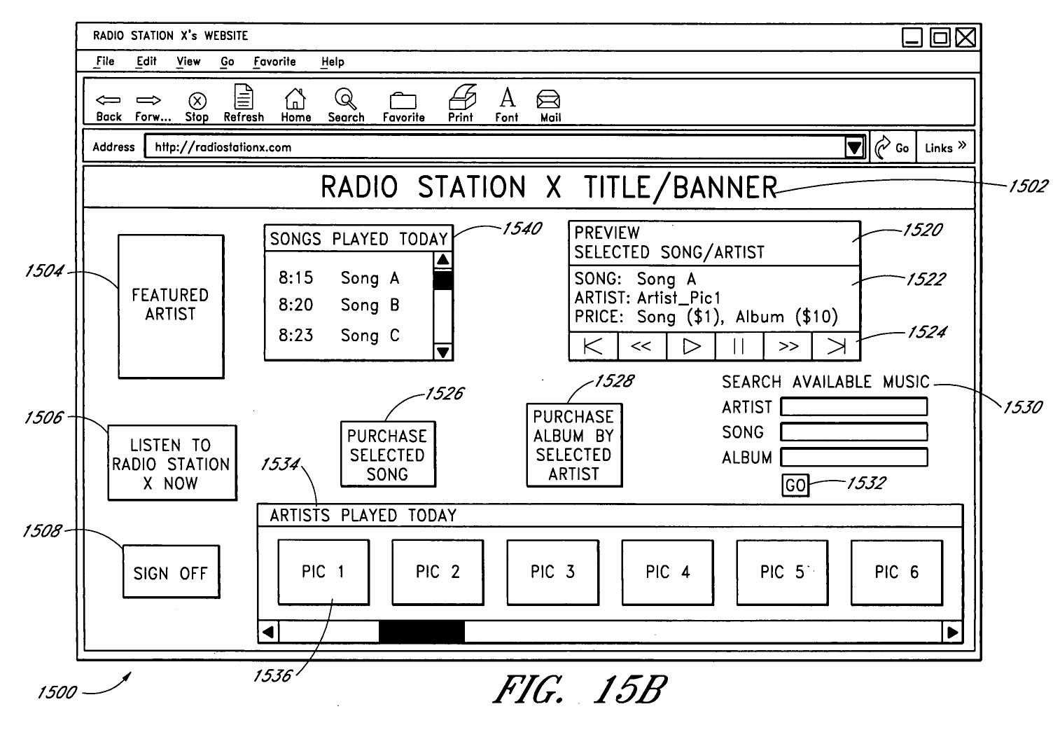

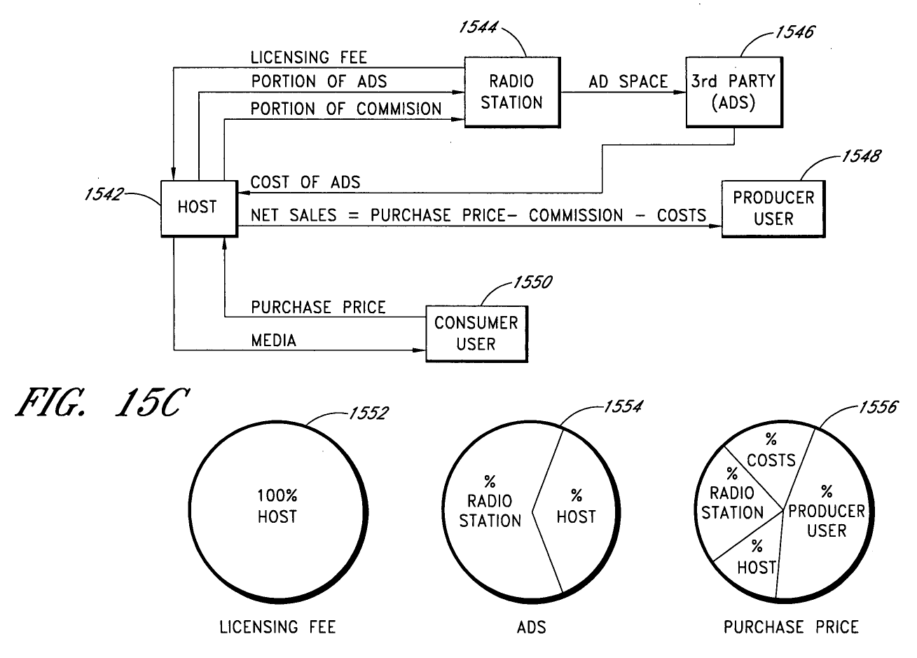

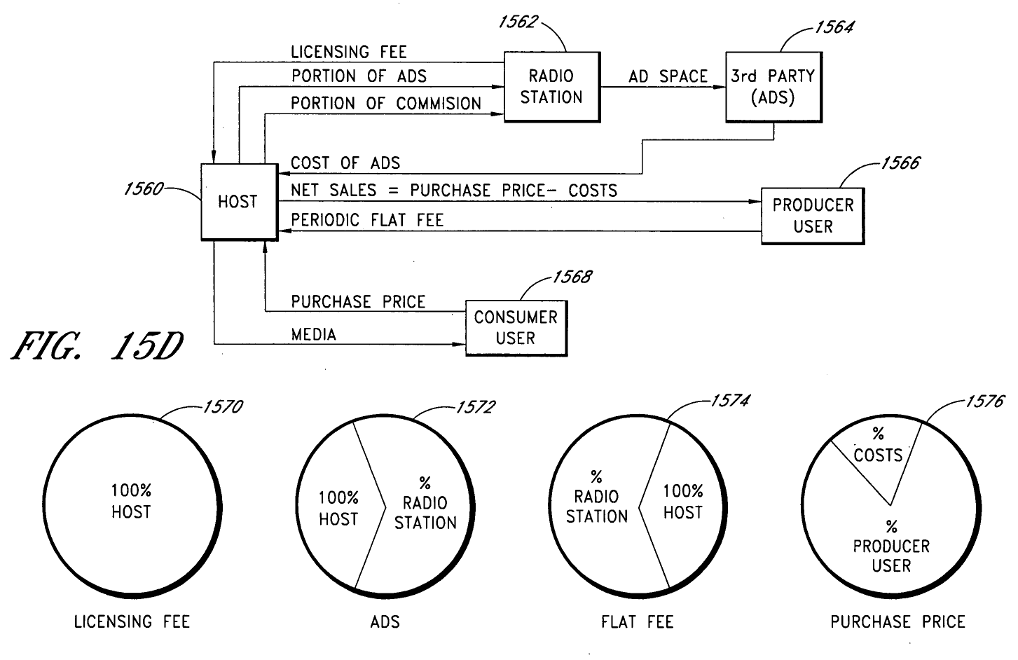

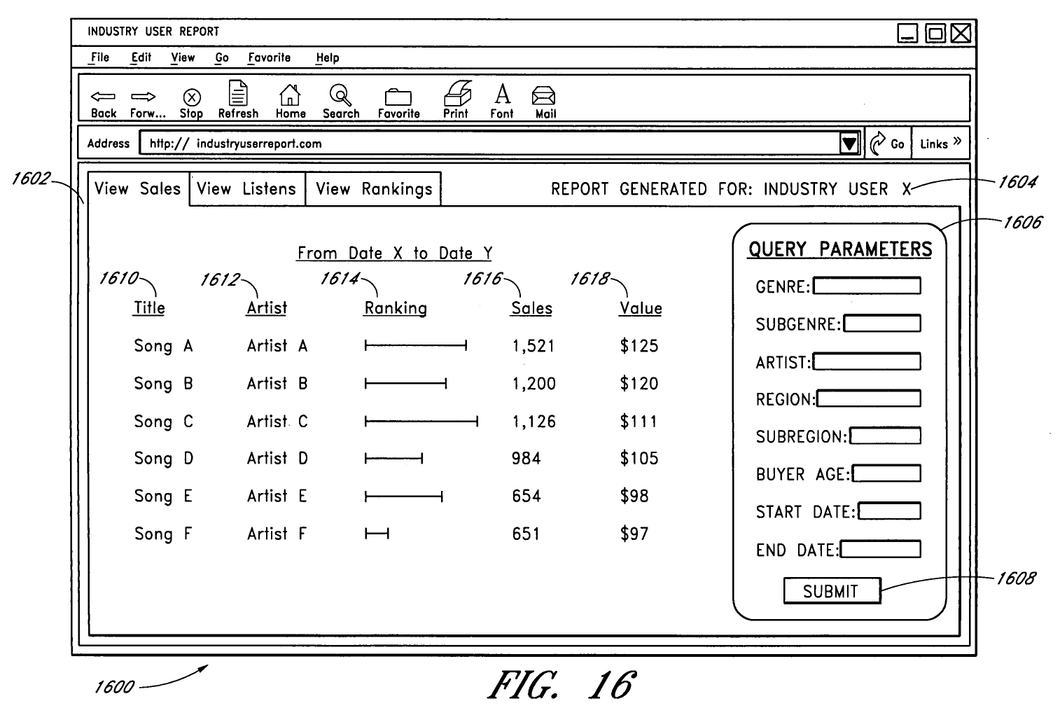

In one embodiment, a sale facilitated by a media distribution center embeds an interface to the host device in a interactive site managed by the media distribution center. For example, a radio station may embed the interface to the host device in the radio station's website. An example of an embedded interface is illustrated in FIG. 15B. All purchases initiated by accessing the radio station's website, but all payment, distribution and media storage occurs on the host side. Then, if the sale is facilitated by the radio station, a portion of the revenue is remitted to two parties: the radio station, and the producer user.

In one embodiment, a sale initiated directly from the host device using an interface managed exclusively by the host device. For example, the host stores all available media files and manages an interactive site such as, for example, a website which permits a user to access the stored media files. When a sale is initiated directly by the host device, a portion of the profit is remitted to two parties: the host and the producer user.

The producer user is required to pay a fee to access services provided by the system. In some embodiments, a producer user may elect to pay either a flat-fee or a commission. A flat-fee is a fixed payment charged to a producer user on a periodic basis. Preferably, the flat-fee is an amount such that the producer user retains, on a per-unit basis, a majority of the purchase price, more than 70% of the purchase price, or more than 80% of the purchase price. Commission is a charge calculated as a percentage of the sales price of the media. Preferably, the commission is in the range of 5-30% of the purchase price, 10-25% of the purchase price or 20%. In one embodiment, the commission may be fixed. In other embodiments, the commission may vary based on the number of units sold in an individual order and/or the total number of units sold by the producer user.

The revenue distribution operation 900 begins 902 by asking whether the sales were initiated through a media distribution center website 904. If the sales were not initiated through a media distribution center website, the host receives and retains all revenue from selling advertising space on the host's website. Also, the host retains revenue generated from other miscellaneous sources such as fees from producer users to feature their titles on the website.

In step 908, when a sale is made, the host receives the gross sales revenue from the purchaser 908. Then, decision block 910 asks whether the producer user pays a flat-fee or is charged a commission to sell its media. If the producer user pays a commission, the host pays the producer user the gross sales less the commission and any applicable transaction costs 916. Examples of transaction costs include processing fees charged by credit card companies, internal processing fees, and/or postage fees (for example, if a producer user wishes to receive payment checks via the postal service). However, if the producer user pays a flat-fee, the host receives and retains the flat-fee from the producer user 912, and the producer user 912 is paid the gross sales revenue less any applicable transaction costs.

In step 918, irrespective of whether the producer user pays a flat-fee or a commission, the host retains the balance of the sales revenue 918 as profits or to cover costs. Then, the revenue distribution operation ends 942.

If, however, sales are initiated through the website of a media distribution center such as a radio station, the host receives a license fee from the media distribution center 920. In one embodiment, the licensing fee is a periodic fixed-fee charged to the media distribution center for use of the host's services. In another embodiment, the licensing fee is a one-time fee paid by the media distribution center. In yet another embodiment, the licensing fee is calculated based on past sales, projected sales, and/or the amount of media stored by the host device.

In step 922, the host receives miscellaneous revenue and revenue generated from the sale of advertising space on some or all of the media distribution center's webpages. The host also receives the gross sales revenue from media sales initiated through the media distribution center's website 924.

Decision block 926 asks whether the producer user is charged a commission or a flat-fee. If the producer user is charged a commission, the host remits to the producer user the gross sales revenue less the commission and any applicable transaction costs 928. Additionally, the host pays the media distribution center a portion of the commission 934. In some embodiments, the portion of the commission may be a negotiated percentage, nothing, or the entire commission. However, if the producer pays a flat-fee, the host receives the flat-fee from the producer user 930 and pays the producer user the gross sales revenue less any applicable transaction costs 932. Additionally, the host pays the media distribution center a portion of the flat-fee 935. In some embodiments, the portion of the flat-fee may be a negotiated price, nothing, or the entire flat-fee.

Irrespective of whether the producer user pays a commission or a flat-fee, the host retains the license fee 936. Additionally, the host pays the media distribution center a portion of the advertising/miscellaneous revenue 938. In some embodiments, the portion of the advertising revenue may be a negotiated percentage, nothing, or the entire amount. If any amount remains, the host retains the balance of the advertising/miscellaneous revenue 940. Also, the host also retains any remaining balance of the commission or flat-fee 939. Then, the revenue distribution operation 900 ends 942.

It is recognized that the invention is not limited to the embodiment depicted in FIG. 12. Rather, a person with ordinary skill in the art will appreciate that the revenue distribution operation 900 can be modified to provide alternative revenue distribution schemes. For example, transaction costs may be incorporated into the purchase price of the media or the host device, and/or and the software used to operate the host device could be sold to the media distribution center for a one-time fee.

### VI. Media Suggestion

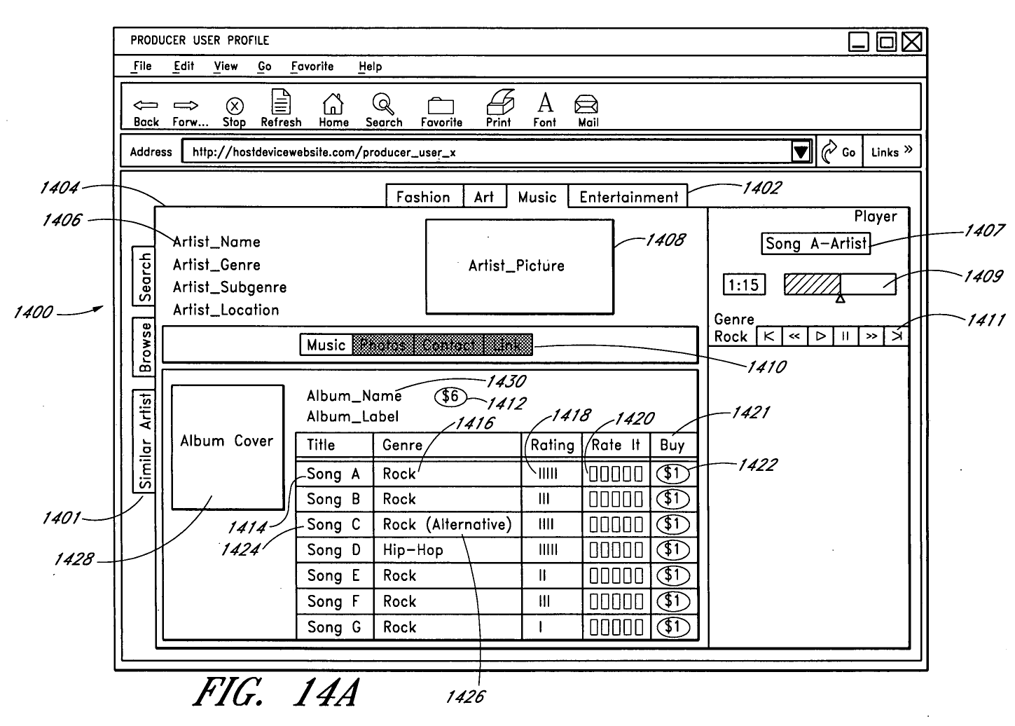

FIG. 13 illustrates one embodiment of a flowchart of operations for suggesting media to a user. In one embodiment, the media suggestion operation 1200 is implemented by the media suggestion module of the host device 214. Media suggestion can be used to automatically suggest media to a user that satisfies the user's preferences. Media is suggested based on the user's media history. Among other things, factors considered when suggesting media include the titles purchased by the user, the titles previewed by the user, the titles previewed by the user but not purchased, the length of time a user previewed the title, and/or a rating of the title provided by the user. The system then compares the user's history to the history of other users to identify matching users. Then, the system suggests media contained within the history of one or more matching users.

The media suggestion operation 1200 begins 1202 by storing a user's history 1204. Each time a user previews, purchases or skips a media fie, it is added to the history. In other embodiments, other considerations may determine whether a title is added to a user's history. As stated above, the operation 1200 may store a wide variety of information associated with the media files the user previewed, purchased or skipped. Additionally, aggregated or computed data related to the user's history may also be stored. For example, the media suggestion operation may store the user's top 25 favorite titles or the user's top 2 favorite genres. Though too exhaustive to list here, a person with ordinary skill in the art will appreciate that a wide variety of media parameters and data combinations may be stored by the media suggestion operation 1200.

In step 1206, the operation 1200 receives the user's history 1206 and compares it to the history of other users on the system 1208. Based on the comparison, the operation 1200 identifies matching users 1210. In one embodiment, the history of a matching user has a threshold degree of commonality with the user's history. Commonality is defined widely and may vary depending on the application or user preferences. For example, commonality may be defined as a percentage or number of identical purchases, a percentage or number of identical previews, a percentage or number of profile views, consumer user group affiliations, and/or demographic similarities.

Next, the operation 1200 suggests the most popular media based on the histories of the matching user(s) 1212. For example, if only one matching user is identified, suggested media includes titles that the matching user has previewed or purchased and the user has not yet previewed or purchased. When multiple matching users are identified, the operation 1200 first identifies media that is common to the history of all or most of the matching users. Then, the operation 1200 suggests to the user the common media files the user has not yet previewed or purchased. For example, the operation may identify matching users that have purchased at least ten songs from Rock Band A and Rock Band B. The comparison of the history and associated demographics may indicate that 18 year olds from the east coast that like Rock Band A and Rock Band B also like Country Band A. Therefore, if an 18 year old user from the East Coast has purchased at least ten songs from Rock Band A and Rock Band B but none from Country Band A, the media suggestion operation will suggest titles created by Country Band A.

It is recognized that the invention is not limited to the embodiment depicted in FIG. 13. Rather, a person with ordinary skill in the art will appreciate that the media suggestion operation 1200 can be modified to implement alternative media suggestion schemes. For example, the media may be suggested on the basis of rhythmic patterns and/or tonal features within one or more audio recordings. Additionally or alternatively, suggested media may be limited or filtered based on user provided preferences.

### VII. Example Applications and Displays

There are many examples for marketing and selling media according to the systems and methods disclosed herein. In particular, the examples include, but are not limited to, (a) the display and revenue distribution method associated with direct sales from a host device, (b) the display and revenue distribution method associated with radio station facilitated sales, and (c) a sample report generated for an industry user. Though other examples may exist, examples of the preceding cases are described below with reference to the figures.

a. Direct Sales from a Host Device

The following example illustrates the sale of media wherein the host device facilitates direct sales of media from its own website. The example also illustrates one method of distributing revenue generated from a sale when the host device facilitates direct sales of media from its own website.

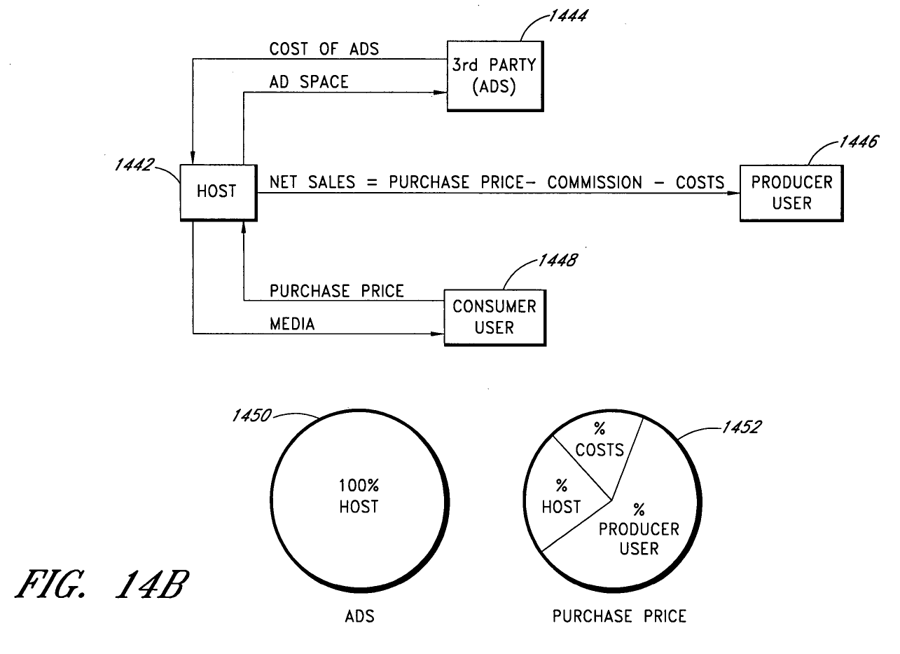

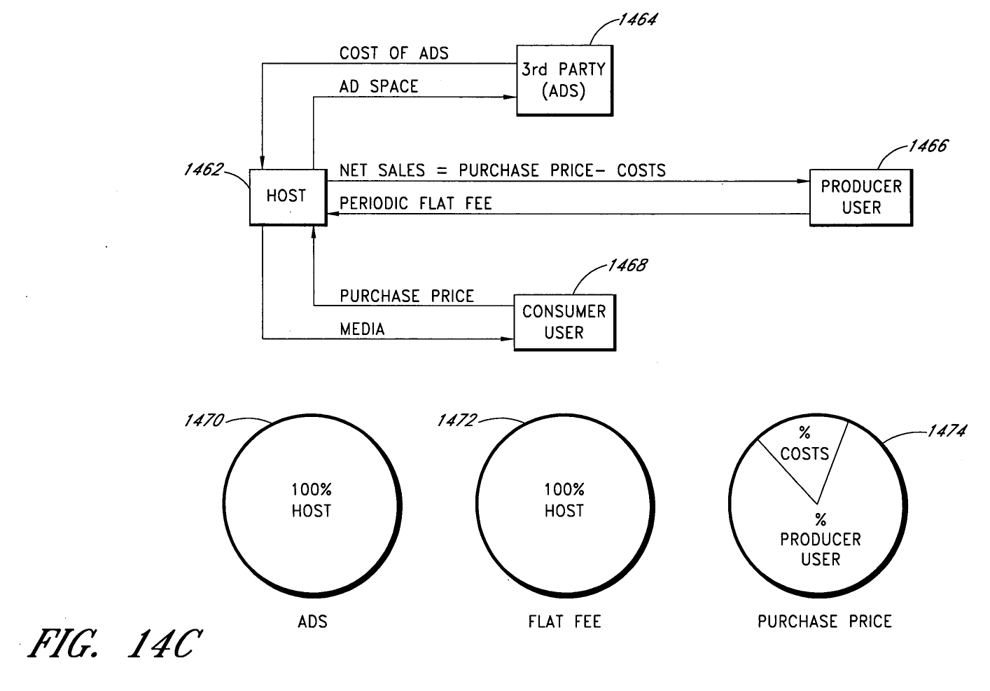

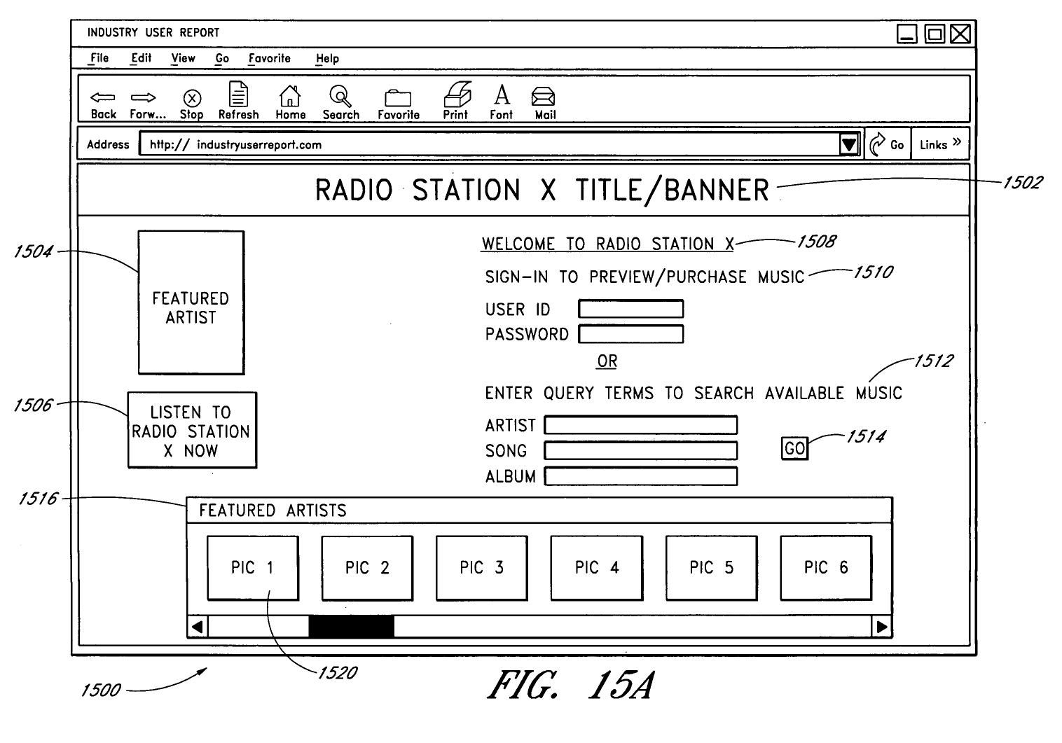

FIG. 14A illustrates an example of a webpage displaying an on-line media storefront where a host device provides direct service. In particular, FIG. 14A displays the profile 1400 of a producer user that has music for sale. The top tabs 1402 permit a user to choose between media types. As shown, the media type selected is “Music.” Therefore, a consumer user viewing the profile 1400 will know that the producer user is a musician. The side tabs 1401 permit a consumer user to quickly navigate to other features of the host's website. For example, the consumer user may search for artists by entering query parameters, browse selected artists (for example, artists featured by the host, artists that have been recently viewed, or the consumer user's favorite artists), or view similar artists suggested by the host.

The profile 1400 includes various fields that contain information about the artist. In particular, field 1406 displays the artist's name, genre, subgenre, and location; field 1408 displays the artist's picture; and field 1410 permits a consumer user to obtain additional information/content from the artist such as media files, additional photographs, contact information, and a link to the artist's website.

Additionally, the profile 1400 contains fields that include information about the media the producer user is offering for sale. Field 1430 displays the name of the artist's album and the record label that produced the album. Field 1428 displays the picture on the album cover.

Table 1421 lists the songs included in the album. Each row in the table 1421 contains information about a single media file. For example, the first row in the table 1421 contains information about the song name 1414, the genre 1416, an average user rating 1418, a field for the consumer user to enter a rating 1420, and a selectable field to purchase the music 1422. All of the songs contained within an album do not need to be associated with the same genre or subgenre. For example, Song A is a rock song, Song C is a rock song in the alternative subgenre, and Song D is a hip hop song.

The consumer user can preview songs by selecting the song title from the table 1421. Accordingly, the previewed artist and song title will appear in field 1407. Additionally, field 1411 allows the user to control the playback of the selected media title, and field 1409 allows a user to further control playback.

A consumer user may also purchase either one title from the artist or a compilation of titles such as an album. To purchase an individual song, a consumer user selects the price 1422 displayed in the buy column of the table. As shown, Songs A through G can be purchased for a dollar. Alternatively, a consumer user may purchase the entire album by selecting the album price displayed in field 1412. As shown, producer users may price the album and individual titles so as to provide a discount if the entire album is purchased (that is, with respect to the total cost of each title). In some embodiments, selecting the price adds the item to a virtual shopping cart without substantially navigating away from the profile 1400. Then, if the user were to select a virtual shopping cart icon (not shown), the user interface would display a list of items the user intends to purchase.

When a song has been purchased, the host device may automatically initiate a download to the consumer user's computer. Alternatively, the song may appear in a selectable list specific to the consumer user's account.

FIG. 14B illustrates a block diagram and pie chart related to an example of a distribution of sales proceeds for an embodiment where a host device provides direct service and a user is charged a commission for selling media. The host 1442 serves as an intermediary between three entities: a producer user 1446, a consumer user 1448, and a 3^{rd} party 1444. Revenue distribution according to FIG. 14B can be characterized as three transactions: a transaction between the host 1442 and each of the three other entities 1444, 1446, 1448. The host 1442 provides advertising space and/or some other miscellaneous service to the 3^{rd} party 1444 in exchange for a payment. The host 1442 distributes media uploaded by the producer user 1446 to the consumer user 1448 in exchange for the purchase price. Finally, the host 1442 remits to the producer user 1446 the net sales proceeds (for example, the purchase price less the commission and any applicable transaction costs). Accordingly, pie chart 1450 indicates that the host 1442 retains 100% of the advertising revenue. Pie chart 1452 shows with regard to the purchase price that a portion is applied toward applicable transaction costs, a portion is retained by the host 1442, and a portion is remitted to the producer user 1446.

FIG. 14C illustrates a block diagram and pie chart related to an example of a distribution of sales proceeds for an embodiment where a host device provides direct service and a user is charged a flat-fee for selling media. The host 1462 serves as an intermediary between three entities: a producer user 1466, a consumer user 1468, and a 3^{rd} party 1464. Revenue distribution according to FIG. 14C can be characterized as three transactions: a transaction between the host 1462 and each of the other three entities 1464, 1466, 1468. The host 1462 provides advertising space and/or some other miscellaneous service to the 3^{rd} party 1464 in exchange for a payment. The host 1462 distributes media uploaded by the producer user 1466 to the consumer user 1468 in exchange for the purchase price. Finally, the host 1462 collects a periodic flat-fee from the producer user 1466 and remits to the producer user 1466 the net sales proceeds (for example, the purchase price less any applicable costs). Accordingly, pie chart 1470 indicates that the host 1462 retains 100% of the advertising revenue, and pie chart 1472 indicates that the host 1462 retains 100% of the flat-fee payment. Pie chart 1474 shows with regard to the purchase price that a portion is applied toward applicable transaction costs, and the balance is remitted to the producer user 1466.

b. Radio Station Facilitated Sales

The following example illustrates the sale of media wherein a radio station facilitates sales of media by embedding an interface to the host device in its website. The example also illustrates one method of distributing revenue generated from a sale when the radio station facilitates the sale of media by embedding an interface to the host device.

FIG. 15A illustrates an example of a webpage 1500 displaying a login screen where a radio station facilitates sales of media. At the top of the webpage 1500 is a banner 1502 indicating the radio station associated with the website and a statement welcoming the user to the website 1508. Additionally, the webpage 1500 shows a single featured artist 1504 and several other featured artists 1516. A user viewing the webpage 1500 may access additional information about a featured artist or see media from the featured artists available for sale by selecting the picture of the artist 1504, 1520.

In field 1506, the webpage displays a selectable area that permits a user to listen to a live broadcast of the radio station. When field 1506 has been selected, live streaming audio is transmitted to the user's computer.

Field 1512 instructs a user to enter query terms to search music associated with the radio station. In the depicted example, a user may search for media by specifying the artist name, song name, and/or album name. After the user has entered the query terms, the user can execute the query by selecting field 1514 marked “GO.”

The webpage 1500 also includes a login area 1510. The login area 1510 has fields for a user to enter a user ID and a password. If the entered user ID and password match a valid user ID and password associated with the website, the user is shown another webpage from the radio station's website that is similar to the one depicted in FIG. 15B.

FIG. 15B illustrates an example of a webpage displaying an on-line media storefront where a radio station facilitates sales of media. The webpage in FIG. 15B contains many of the fields included in the login webpage but provides additional features. In particular, a user can preview titles by an artist by selecting a featured artist's picture 1504, 1536. Alternatively, a title can be previewed by selecting the title from the “Songs Played Today” field 1540 which shows all the titles played by the radio station that day.

In the “Preview Selected Song/Artist” field 1520, the user is shown the selected artist and song along with the purchase price 1522. The user can control playback of the selected song or select another song in a list by manipulating the playback controls 1524.

A user may also choose a selected song by searching for the song by entering the query terms in field 1530. After the query terms have been entered and the user presses “GO” 1532, the search results are displayed on the webpage 1500. For example, the search results could appear in a unique location on the webpage 1500 or appear in place of the “Artists Played Today” field 1534 or the “Songs Played Today” field 1540.

If, after previewing the song, the user wants to purchase the song, the user may select the field labeled “Purchase Selected Song” 1526. Alternatively, the user may select the field labeled “Purchase Album by Selected Artist” 1528 to purchase the entire album. In other embodiments, fields 1526 and 1528 can be dynamically updated to reflect the purchase price of the song or album.

When a song has been purchased, the host device may automatically initiate a download to the consumer user's computer. Alternatively, the song may appear in a list of purchased media specific to the consumer user's account so that the song is available for repeated download.

FIG. 15C illustrates a block diagram and pie chart related to an example of a distribution of sales proceeds for an embodiment where a radio station facilitates sales of media and a user is charged a commission for selling media. The 3^{rd} party 1546 is provided advertising space by the radio station 1544 in exchange for a payment to the host 1542. The consumer user 1550 pays the host 1542 the purchase price in exchange for copy of a media file uploaded by the producer user 1548. The radio station 1544 pays the host 1542 a licensing fee in exchange for embedding the host device interface in its website. Accordingly, the radio station. 1544 receives a portion of the advertising/miscellaneous revenue and a portion of the sales commission generated by way of sales through the radio station's 1544 website. Finally, the producer user 1548 receives the net sales proceeds (for example, the purchase price less commission and any applicable transaction costs) in exchange for providing media for sale on the radio station's 1544 website.

Pie charts 1552, 1554, and 1556 summarize the revenue distribution when a radio station 1544 facilitates media sales and a producer user 1548 is charged a commission on all sales. Pie chart 1552 indicates that the host 1542 retains 100% of the licensing fee paid by the radio station 1544. Pie chart 1554 shows that the host 1542 remits a portion of the advertising revenue to the radio station 1544 and retains the balance. Pie chart 1556 indicates that the a portion of the purchase price is applied toward applicable transaction costs, a portion of the purchase price (for example, a portion of the commission) is remitted to the radio station 1544, a portion of the purchase price (for example, the net sales proceeds) is remitted to the producer user 1548, and the balance of the purchase price is retained by the host 1542.

FIG. 15D illustrates a block diagram and pie chart related to an example of a distribution of sales proceeds for an embodiment where a radio station facilitates sales of media and a user is charged a flat-fee for selling media. The 3^{rd} party 1564 is provided advertising space by the radio station 1562 in exchange for a payment to the host 1560. The consumer user 1568 pays the host 1560 the purchase price in exchange for a copy of a media file uploaded by the producer user 1566. The radio station 1562 pays the host 1560 a licensing fee in exchange for embedding the host device interface in its website. Accordingly, the radio station 1562 receives a portion of the advertising/miscellaneous revenue and a portion of the sales commission generated by way of sales through the radio station's 1562 website. Finally, the producer user 1566 receives the net sales proceeds (for example, the purchase price less transaction costs) in exchange for providing media for sale on the radio station's 1544 website and paying the host 1560 a periodic flat-fee.

Pie charts 1570, 1552, 1554, and 1556 summarize revenue distribution when a radio station 1562 facilitates media sales and a producer user 1566 is charged a periodic flat-fee. Pie chart 1570 indicates that the host 1560 retains 100% of the licensing fee paid by the radio station 1562. Pie chart 1572 shows that the host 1560 remits a portion of the advertising revenue to the radio station 1562 and retains the balance. Pie chart 1576 indicates that a portion of the purchase price is applied toward applicable transaction costs, and the balance of the purchase price is remitted to the producer user 1566.

These examples serve to illustrate the flexibility in revenue distribution offered by the systems and methods disclosed herein. The flexibility is advantageous to producer users for two reasons: (a) using a commission-based method, a producer user does not incur any startup costs, and (b) when sales increase, the producer user can decrease per-unit cost by utilizing a flat-fee payment method. For example, an artist with no money and no market recognition may begin by choosing to pay a commission on all sales. As the artist's work becomes more popular and revenue increases, the flat-fee payment method may be more advantageous. Accordingly, the producer can switch over the flat-fee payment. Additionally, a producer user can utilize this flexibility when entering new markets. For example, if a producer user has a relatively small market presence on the East Coast, the producer user can choose to pay a commission when marketing her music via an East Coast radio station. In contrast, in West Coasts markets where the producer user is popular, the producer user should choose a flat-fee payment method when marketing her music via a West Coast radio station. Moreover, the flat-fee and the commission rates are generally substantially lower than those charged by major record labels. In particular, some embodiments charge a flat-fee or a commission that 30% or less of gross sales revenue.

c. Report Generation

FIG. 16 illustrates one embodiment of a webpage displaying an example of a report generated for a user. The webpage 1600 includes various fields. The title of the report 1604 appears in the upper right hand corner of the webpage 1600 and indicates the intended recipient of the report. In some embodiments, the title 1604 may also summarize the contents of the report. In the top left hand corner are tabs 1602 that permit a user to navigate between different pages that comprise the report. In the depicted embodiment, the tabs 1602 permit the user to view media titles ordered by sales, media titles ordered by the number of user listens, and media titles ordered by rankings. In other embodiments the tabs may be used to navigate between more than one report or multiple pages of the same report. The right side of the webpage 1600 provides a field 1606 for entering query parameters. A query is executed when the user selects “SUBMIT” 1608. In one embodiment, a user may use the query field 1606 to filter the report results according to the query parameters. In another embodiment, a user may use the query field 1606 to generate customized reports.

The table that appears in the webpage 1600 contains the data identified by the report. The example depicted contains five columns of data: the song title 1610, the artist associated with the song title 1612, the average user rating of the song title 1614, the number of copies sold 1616, and the sales revenue 1618. In one embodiment, selecting a column title orders the report according to that column.

Alternative embodiments of a report generated by the systems and methods disclosed herein are also contemplated. In particular, the contents of a report can be formatted to adapt to the special requirements of the device receiving the report. For example, special formatting may be required when viewing the report on the small display area of a cellular telephone.

### VIII. Other Embodiments

While certain embodiments of the invention have been described, these embodiments have been presented by way of example only, and are not intended to limit the scope of the present invention. Accordingly, the breadth and scope of the present invention should be defined in accordance with the following claims and their equivalents.

By way of example, the following alternatives are also contemplated. Although the systems and methods described herein have been directed to a host device that stores media in a central location, some embodiments of the invention may utilize a distributed storage system where media files are stored locally on user computers. The systems and methods herein may also be implemented such that payment is routed directly from a consumer user to a producer user. In some embodiments, purchased media files may be copyright protected so as to restrict a user's ability to copy the media files. Additionally, though some of the systems and methods are directed to emerging artists, emerging artists should be construed to at least include new artists, established artists, producers, creators, commercial labels, independent artists, consortiums, organizations, talent agents, talent scouts, and traditional media sources.

The above-mentioned alternatives are examples of other embodiments, and they do not limit the scope of the invention. It is recognized that a variety of data structures with various fields and data sets may be used. In addition, other embodiments of the flow charts may be used.

What is claimed is:

1. An apparatus to generate a playlist of media created by emerging artists for use by a media distribution center in response to purchasing decisions stored on a website, comprising:
a storage unit configured to receive and store a plurality of media titles from a plurality of emerging artists;
an interface for communicating data associated with at least a portion of the stored media titles;
a processor in communication with said storage unit and said interface configured to:
permit a plurality of users to purchase a media title from the emerging artists;
record sales data associated with the media titles;
generate a playlist of selected media titles in response to parameters associated with the media titles and selected by a media distribution center, wherein at least one of the parameters is related to a the sales data; and
transmit data associated with the selected media titles to the interface.

2. The apparatus of claim 1, wherein the interface is an input/output interface for communicating via a communication medium.

3. The apparatus of claim 1, wherein the playlist comprises the most popular media titles, as determined by the sales data, that satisfy the other parameters.

4. The apparatus of claim 1, wherein the interface transmits data to a media distribution center for broadcast.

5. The apparatus of claim 1, wherein the interface transmits data to a portable media device for playback by a reviewer or promoter of creative talent.

6. A method for generating a playlist of media created by emerging artists for use by a media distribution center in response to purchasing decisions stored on a website, comprising:
storing a plurality of media titles from a plurality of emerging artists;
communicating data associated with at least a portion of the stored media titles;
permitting a plurality of users to purchase a media title from the emerging artists;
recording sales data associated with the media titles;
generating a playlist of selected media titles in response to parameters associated with the media titles and selected by a media distribution center, wherein at least one of the parameters is related to a the sales data; and
transmitting data associated with the selected media titles.

7. The method of claim 6, wherein the data associated with the selected media titles is transmitted by an input/output interface via a communication medium.

8. The method of claim 6, wherein the playlist comprises the most popular media titles, as determined by the sales data, that satisfy the other parameters.

9. The method of claim 6, wherein the data associated with the selected media titles is transmitted to a media distribution center for broadcast.

10. The method of claim 6, wherein the data associated with the selected media titles is transmitted to a portable media device for playback by a reviewer or promoter of creative talent.

11. An apparatus to receive electronic media data from creators of entertainment media to be promoted and sold to the general public, comprising:
a user input device for receiving demographic data from an emerging artist;
a storage unit configured to receive and store media from the emerging artist; and
a processor coupled to said storage unit and configured to:
create a multi-page website display unique to the emerging artist incorporating the emerging artist's media and other information about the emerging artist including the demographic data;
permit a consumer user to purchase the media for a purchase price using the website;
remit a portion of the purchase price of the media to the emerging artist; and
transmit a digital version of the media to the consumer user.

12. The apparatus of claim 11, wherein greater than fifty percent of the purchase price is remitted to the emerging artist.

13. The apparatus of claim 11, wherein seventy to eighty percent of the purchase price is remitted to the emerging artist.

14. The apparatus of claim 11, wherein one hundred percent of the purchase price less costs is remitted to the emerging artist in exchange for a periodic flat-fee.

15. The apparatus of claim 11, wherein the emerging artist is capable of deciding between whether to (a) pay a flat fee in exchange for the purchase price less costs or (b) pay a commission on the purchase price.

16. A method for receiving electronic media data from creators of entertainment media to be promoted and sold to the general public, comprising:
receiving demographic data from an emerging artist;
receiving and store media from the emerging artist;
creating a multi-page website display unique to the emerging artist incorporating the emerging artist's media and other information about the emerging artist including the demographic data;
permitting a consumer user to purchase the media for a purchase price using the website;
remitting a portion of the purchase price of the media to the emerging artist; and
transmitting a digital version of the media to the consumer user.

17. The method of claim 16, wherein greater than fifty percent of the purchase price is remitted to the emerging artist.

18. The method of claim 16, wherein seventy to eighty percent of the purchase price is remitted to the emerging artist.

19. The method of claim 16, wherein one hundred percent of the purchase price less costs is remitted to the emerging artist in exchange for a periodic flat-fee.

20. The method of claim 16, wherein the emerging artist is capable of deciding between whether to (a) pay a flat fee in exchange for the purchase price less costs or (b) pay a commission on the purchase price.

21. A method for rapidly creating a functional on-line storefront for emerging artists to market and sell their media, comprising:
receiving registration information relating to a producer user;
receiving media and parameters corresponding to the media;
storing the media on a first storage device and providing substantially immediate access to the media via the first storage device;
copying the media from the first storage device to a second storage device and providing access to the media via the first storage device while the media is being copied;
providing access to the media via the second storage device after the media has been copied to the second storage device; and
permitting users to purchase or preview the media when the media is stored on either the first storage device or the second storage device.

22. The method of claim 21, wherein the media is at least one of an artwork, a drawing, a painting, a lithograph, a reproduction, a photograph, music, a soundtrack, a musical score, a lyrical work, an animation, a design or design element, sheet music, an audio recording, a video, a movie, a short film, a television program, an audio/visual recording, attire, fashion, and a wearable article.

23. The method of claim 21, wherein the parameters corresponding to the media may include, but is not limited to, at least one of a name, artist, album, genre, sub-genre, region, sub-region, price, and source.

24. The method of claim 21, wherein the first storage device is a hard disk associated with a local web server.

25. The method of claim 21, wherein the second storage device is a hard disk associated with a host device that stores media from more than one producer user.

26. The method of claim 21, further comprising:
storing a first address for the media stored in the first storage device in a database;
storing a second address for the media stored in the second storage device in the database; and
deleting the media from the first storage device.

27. The method of claim 21, wherein the first storage device is at least one of a magnetic storage medium, a hard disk, a read-only memory, a random access memory, an optical disk, an EEPROM, and a flash memory.

28. The method of claim 21, wherein the second storage device is at least one of a magnetic storage medium, a hard disk, a read-only memory, a random access memory, an optical disk, an EEPROM, and a flash memory.

29. The method of claim 21, further comprising:
tracking the number of times a producer user's profile is viewed;
tracking the number of times a media file associated with the producer user is played or viewed; and
tracking sales data associated with the producer user.

30. The method of claim 29, wherein tracking sales data comprises tracking the demographic and contextual information of a consumer user related to the play, viewing, or sale of a producer user's media by the consumer user, the demographic data including at least one of age, gender, region, other media, and a user rating of media.

31. The method of claim 21, wherein permitting users to purchase media utilizes a virtual shopping cart that shows a list of items a user intends to purchase.

32. A system for rapidly creating a functional on-line storefront for emerging artists to market and sell their media, comprising:
a computer; and
software accessible to and executable by the computer such that the computer is operable to:
receive registration information relating to a producer user;
receive media and parameters corresponding to the media;
store the media on a first storage device coupled locally to the computer;
provide access to the media via the first storage device;
transmit a copy of the media from the first storage device to a second storage device;
provide access to the media via the second storage device after the media has been copied to the second storage device; and
permit users to purchase or preview the media when the media is stored on either the first storage device or the second storage device.

33. The system of claim 32, wherein the first storage device is a hard disk associated with a local web server.

34. The system of claim 32, wherein the second storage device is a hard disk associated with a host device that stores media from more than one producer user.

35. The system of claim 32, the software further configured to:
store a first address for the media stored in the first storage device in a database;
store a second address for the media in the database stored in the second storage device; and
deleting the media from the first storage device.

36. A user interface for displaying media and purchasing media from emerging artists via a media distribution center, comprising:
a first selection area embedded in a display associated with a media distribution center that permits a user to select a media file;
a second selection area embedded in the display associated with the media distribution center that permits a user to preview the selected media file; and
a third selection area embedded in the display associated with the media distribution center configured to:
entirely initiate and complete payment for the selected media file from a website owned by the media distribution center; and
entirely initiate and complete distribution of the selected media file from the website owned by the media distribution center.

37. The user interface of claim 36, wherein the selected media file is purchased by a user and distributed to the user without significant redirection to a website hosted by a server different from the one hosting the website owned by the media distribution center.

38. The user interface of claim 36, wherein the media distribution center is at least one of a terrestrial radio station, a satellite radio station, an internet streaming radio station, a terrestrial television station, a cable television station, a satellite television station, an internet streaming media station, an on-demand media station, and an internet website.

39. The user interface of claim 36, further comprising a list of media played by the media distribution center and available for purchase.

40. The user interface of claim 36, further comprising a query field embedded in the display configured to accept query parameters to search for the selected media file.

41. The user interface of claim 36, further comprising a login field configured to authenticate the identity of a user.

42. The user interface of claim 41, wherein the display is configured to accept a modification to a user's profile.

43. The user interface of claim 42, wherein the modification is at least one of entering biographical information, entering payment information, and uploading media.

44. The user interface of claim 36, further comprising a fourth selection area that permits the user to view a virtual shopping cart that shows a list of items a user intends to purchase.

45. A fee based method for directly distributing, marketing and selling media produced by an emerging artist using a digital interface, comprising:
receiving a periodic fixed payment from a producer user;
permitting the producer user to display media available for purchase;
displaying a purchase price associated with the media;
receiving a payment from a consumer user in the amount of the purchase price;
distributing the media to the consumer user; and
distributing net sales proceeds to the producer user.

46. The method of claim 45, wherein the net sales proceeds is the purchase price less any applicable transaction costs.

47. The method of claim 45, further comprising:
providing advertising space on a display screen shared by the displayed media available for purchase; and
receiving payment for the advertising space.

48. A commission based method for directly distributing, marketing and selling media produced by an emerging artist using a digital interface, comprising:
permitting a producer user to display media available for purchase;
displaying a purchase price associated with the media;
receiving a payment from a consumer user in the amount of the purchase price;
distributing the media to the consumer user; and
distributing net sales proceeds less a commission to the producer user.

49. The method of claim 48, wherein the net sales proceeds is the purchase price less any applicable transaction costs.

50. The method of claim 48, further comprising:
providing advertising space on a display screen shared by the displayed media available for purchase; and
receiving payment for the advertising space.

51. A fee based method for using a media distribution center's website to directly distribute, market and sell media produced by an emerging artist, comprising:
receiving a periodic fixed payment from a producer user;
receiving a license fee from a media distribution center;
permitting the producer user to display media available for purchase on a display screen associated with the media distribution center;
displaying a purchase price associated with the media on the display screen;
receiving a payment from a consumer user in the amount of the purchase price;
distributing the media to the consumer user;
distributing at least some of the periodic fixed payment to the media distribution center; and
distributing net sales proceeds to the producer user.

52. The method of claim 51, wherein the net sales proceeds is the purchase price less any applicable transaction costs.

53. The method of claim 51, further comprising:
providing advertising space on the display screen;
receiving an advertising fee for the advertising space; and
distributing at least some of the advertising fee to the media distribution center.

54. A commission based method for using a media distribution center's website to directly distribute, market and sell media produced by an emerging artist, comprising:
receiving a license fee from a media distribution center;
permitting the producer user to display media available for purchase on a display screen associated with the media distribution center;
displaying a purchase price associated with the media on the display screen;
receiving a payment from a consumer user in the amount of the purchase price;
distributing the media to the consumer user;
distributing net sales proceeds less a commission to the producer user; and
distributing at least some of the commission to the media distribution center.

55. The method of claim 54, wherein the net sales proceeds is the purchase price less any applicable transaction costs.

56. The method of claim 54, further comprising:
providing advertising space on the display screen;
receiving an advertising fee for the advertising space; and
distributing at least some of the advertising fee to the media distribution center.

57. An artwork sales method for the promotion of emerging artists, comprising:
displaying an artwork available for sale from a producer user;
displaying a purchase price associated with the artwork;
displaying the number of copies of the artwork that are available for sale;
receiving payment from a consumer user in the amount of the purchase price of the artwork;
transmitting a notification to the producer user indicating that a purchase has been made;
distributing to the producer user (a) net sales proceeds if the producer user pays a periodic fixed fee, or (b) net sales proceeds less a commission if the producer user does not pay a periodic fixed fee; and
decrementing the number of copies available for sale in response to the consumer user's purchase.

58. The artwork sales method of claim 57, further comprising receiving a representation of available inventory from the producer user.

59. A method for keeping a talent industry executive abreast of notable events and recent developments in market trends, comprising:
receiving one or more criteria from an industry user;
monitoring parameters associated with media files to determine when the one or more criteria have been satisfied;
generating a customized report summarizing the market activity of media files based on the one or more criteria; and
transmitting a notification to the industry user indicating that the customized report is available to view.

60. The method of claim 59, wherein the one or more criteria include at least one of a age of the target demographic, a genre, a subgenre, a region, a subregion, a media type, an artist, a title, a compilation of works, an album, a desired notification frequency, a notification triggering event, a number of units sold, a value of units sold, a ranking, a production label, an individual, a duration, and a medium.

61. The method of claim 60, wherein the customized report comprises:
an indication of the criteria used to generate the customized report; and
a table comprising:
an artist field;
a media title field;
a ranking field; and
least one of a number of units sold field and a value of units sold field.

62. The method of claim 61, wherein the customized report further comprises a query field that permits the industry user to modify the one or more criteria in order to generate a new customized report based on the modified one or more criteria.

63. The method of claim 59, wherein the notification is transmitted to at least one of a mobile telephone, a personal digital assistant, an email account, a voicemail, a pager, a fax machine, a mailbox, and a website.

64. The method of claim 63, wherein the notification includes the customized report.

65. A system for keeping a talent industry executive abreast of notable events and recent developments in market trends, comprising:
a computer; and
software accessible to and executable by the computer such that the computer is operable to:
receive one or more criteria from an industry user;
monitor parameters associated with media files to determine when the one or more criteria have been satisfied;
generate a customized report summarizing the market activity of media files based on the one or more criteria; and
transmit a notification to the industry user indicating that the customized report is available to view.

66. The system of claim 65, wherein the one or more criteria include at least one of a age of the target demographic, a genre, a subgenre, a region, a subregion, a media type, an artist, a title, a compilation of works, an album, a desired notification frequency, a notification triggering event, a number of units sold, a value of units sold, a ranking, a production label, an individual, a duration, and a medium.

67. The system of claim 66, wherein the customized report comprises:
a field indicating the criteria used to generate the customized report; and
a table comprising:
an artist field;
a media title field;
a ranking field; and
at least one of a number of units sold field and value of units sold field.

68. The system of claim 68, wherein the customized report further comprises a query field that permits the industry user to modify the one or more criteria in order to generate a new customized report based on the modified one or more criteria.

69. The system of claim 65, wherein the notification is transmitted to at least one of a mobile telephone, a personal digital assistant, an email account, a voicemail, a pager, a fax machine, a mailbox, and a website.

70. The system of claim 69, wherein the notification includes the customized report.

71. A system for querying a database that stores information related to media files in order to identify one or more desired media files, comprising:
a computer; and
software accessible to and executable by the computer such that the computer is operable to:
receive one or more criteria, including a geographic source of media file;
identify matching media files that satisfy the one or more criteria; and
provide an indication that a media file is a matching media file.

72. The system of claim 71, wherein the computer is further operable to specify the geographic source is specified by a user selecting a region on a map.

73. The system of claim 72, wherein the geographic source is specified by selecting a subregion on the map.

74. The system of claim 73, wherein the computer is further operable to provide a higher resolution version of the map in response to the selection of the region, permitting selection of the subregion on the higher resolution version of the map.

75. A method for querying a database that stores information related to media files in order to identify one or more desired media files, comprising:
receiving one or more criteria, including a geographic source of a media file;
identifying matching media files that satisfy the one or more criteria; and
providing an indication that a media file is a matching media file.

76. The method of claim 75, further comprising selecting a region on a map to indicate the geographic source of the media file.

77. The method of claim 76, further comprising selecting a subregion on the map to indicate the geographic source of the media file.

78. The method of claim 77, further comprising:
providing a higher resolution version of the map in response to selecting the region; and
selecting a subregion on the higher resolution version of the map.

79. A system for automatically suggesting media to a user based on the prior media preferences of the user, comprising:
a computer; and
software accessible to and executable by the computer such that the computer is operable to:
receive a target user history that is an indication of the media files a target user has accessed in the past;
identify one or more matching users that have a similar user history to the target user; and
provide a suggested media file to the target user based on (a) a comparison of the target user histories and media files, and (b) whether the target user history includes the suggested media file.

80. The system of claim 79, wherein the one or more matching users have accessed at least a threshold number of media files that appear in the target user history.

81. The system of claim 79, wherein the one or more matching users are identified based on the media files that the target user has accessed without interruption.

82. A method for automatically suggesting media to a user based on the user's prior media preferences, comprising:
receiving a target user history that is an indication of the media files a target user has accessed in the past;
identifying one or more matching users that have a similar user history to the target user; and
providing a suggested media file to the target user based on (a) a comparison of the target user history and media files common to the user histories of the matching users, and (b) whether the target user history includes the suggested media file.

83. The method of claim 82, wherein the one or more matching users have accessed at least a threshold number of media files that the target user has accessed in the past.

84. The method of claim 82, wherein the one or more matching users are identified based on the media files that appear in the target user history.

85. A method for automatically delivering to a talent scout media files that match the scouting interests of the talent scout, comprising:
receiving one or more criteria from an industry user;
identifying a list of one or more matching media files that satisfy the one or more criteria;
delivering to the industry user the one or more matching media files; and
updating the list of one or more media files by (a) removing from the list media files that have already been accessed by the industry user and (b) adding to the list media files that (i) satisfy the one or more criteria and (ii) have never been an entry in the list.

86. The method of claim 85, wherein the identified population of one or more media files is delivered to a device that is at least one of an mp3 player, a portable audio device, a mobile telephone, a personal computer, a website, a storage device, a gallery, a media distribution center, a conference, an exhibition, a showcase, and a personal digital assistant.

87. The method of claim 86, wherein each time the list is updated, the media files stored on the device are automatically updated according to the list.

88. A system for automatically delivering to a talent scout media files that match the scouting interests of the talent scout, comprising:
a computer; and
software accessible to and executable by the computer such that the computer is operable to:
receive one or more criteria from an industry user;
create a list of one or more matching media files that satisfy the one or more criteria;
deliver to the industry user the one or more matching media files; and
update the list of one or more media files by (a) removing from the list media files that have already been accessed by the industry user and (b) adding to the list media files that (i) satisfy the one or more criteria and (ii) have never been an entry in the list;

89. The system of claim 88, wherein the identified population of one or more media files is delivered to a device that is at least one of an mp3 player, a portable audio device, a mobile telephone, a personal computer, a website, a storage device, and a personal digital assistant.

90. The system of claim 89, wherein each time the list is updated, the media files stored on the device are automatically updated according to the list.

91. A method for automatically generating a media file playlist, comprising:
receiving one or more criteria from a user;
identifying one or more matching media files that satisfy the one or more criteria;
creating a list comprising the one or more media files; and
playing the media files according to the list.

92. The method of claim 91, further comprising:
receiving a preference from the user; and
ordering the list in response to the preference.

93. The method of claim 91, wherein the one or more criteria are automatically determined based on media files accessed by one or more participating users in the past.

94. The method of claim 91, further comprising transmitting media files in the list via a media distribution center that is at least one of a terrestrial radio station, a satellite radio station, an internet streaming radio station, a terrestrial television station, a cable television station, a satellite television station, an internet streaming media station, an on-demand media station and an internet website.

95. The method of claim 94, wherein the media files in the list are transmitted in a virtual community environment including at least one of a video game, a chat room, a bulletin board service, a discussion forum, a virtual reality environment, a communication-based environment, and a blog.

96. The method of claim 95, further comprising permitting a member of the virtual community environment to purchase a media file in the list.

97. A system for automatically generating a media file playlist, comprising:
a computer; and
software accessible to and executable by the computer such that the computer is operable to:
receive one or more criteria from a user;
identify one or more matching media files that satisfy the one or more criteria;
create a list comprising the one or more media files; and
play the media files according to the list.

98. The system of claim 97, wherein the computer is further operable to:
receive a preference from the user; and
order the list in response to the preference.

99. The system of claim 97, wherein the one or more criteria are automatically determined based on media files that have been accessed by one or more participating users in the past.

100. The system of claim 97, wherein the computer is further operable to transmit media files in the list so that they can be broadcast via a media distribution center that is at least one of a terrestrial radio station, a satellite radio station, an internet streaming radio station, a terrestrial television station, a cable television station, a satellite television station, an internet streaming media station, an on-demand media station and an internet website.

101. The system of claim 100, wherein the media files in the list are transmitted in a virtual community environment including at least one of a video game, a chat room, a bulletin board service, a discussion forum, a virtual reality environment, a communication-based environment, and a blog.

102. The system of claim 101, further comprising permitting a member of the virtual community environment to purchase a media file in the list.

103. An apparatus for receiving media data to be promoted and sold to the general public, comprising:
an input device for receiving demographic data from a producer user;
a media receiving unit configured to receive media from the producer user; and
a processor coupled to the media receiving unit and configured to:
create a playlist of media titles for playback by a reviewer; and
transmit the playlist of media titles and demographic data to the reviewer's removable storage device whereby the reviewer can quickly collect all the media data deposited by the producer user and review it at his/her leisure.

104. The apparatus of claim 103, further comprising:
a printer for (a) generating reports that include the demographic data, or (b) printing visual media.

105. The apparatus of claim 103, further comprising:
a creator coupled to the processor for creating a copy of media on a low-cost storage medium.

106. The apparatus of claim 105, wherein the low-cost storage medium comprises at least one of a CD, a DVD, a magnetic storage medium, and an optical disk.

107. The apparatus of claim 106, wherein the comments from the reviewer can be entered on the removable storage device and uploaded to a central location for examination.
